(19) United States
(12) Patent Application Publication
(10) Pub. No.: US 2009/0247730 A1
(43) Pub. Date: Oct. 1, 2009

(54) METHOD OF PRODUCING A POLYMER-PROCESSED ORGANIC FINE PARTICLE DISPERSION

(75) Inventors: Hirokazu Kyota, Ashigarakami-gun (JP); Hideki Maeta, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/412,763

(22) Filed: Mar. 27, 2009

(30) Foreign Application Priority Data
Mar. 31, 2008 (JP) JP 2008-092927

(51) Int. Cl. C08G 73/06

(52) U.S. Cl. 528/423

(57) ABSTRACT

A method of producing a polymer-processed organic fine particle dispersion, having a step of: feeding an organic fine particle dispersion containing a polymerizable compound in a channel and polymerizing the polymerizable compound during the flow of the dispersion in the channel.

This non-provisional application claims priority under 35 U.S.C. § 119 (a) on Patent Application No. 2008-092927 filed in Japan on Mar. 31, 2008, which is entirely herein incorporated by reference.

### FIELD OF THE INVENTION

The present invention relates to a method of producing a polymer-processed organic fine particle dispersion.

### BACKGROUND OF THE INVENTION

Examples of applications of pulverizing and dispersing organic materials include pigments. Pigments generally exhibit vivid color tone and high coloring power, and they are widely used in many fields. Examples of use applications in which pigments are used include paints, printing inks, electrophotographic toners, ink-jet inks, and color filters. Applications of particularly practical importance that require high performance include color filters and ink-jet inks.

In recent years, reduction in color filter thickness has been strongly required for achieving an increase in pixel count of apparatus associated with imaging, such as liquid crystal displays, CCD sensors or digital cameras. To reduce in color filter thickness, it is essential that finer pigments be used in the color filters. In addition, development of pigment fine particles with uniformity and minuteness is required for ensuring higher contrast in color filters. In other words, development of pigment fine particles with minuteness, uniformity and stability holds the key to achieving high performance of apparatus associated with imaging.

On the other hand, dyes have been so far used as coloring materials of ink-jet inks. However, dyes are inferior in water resistance and light stability. So, pigments have come to be used for improvements in ink-jet ink properties. And it is being tried to apply ink jet technology to not only a printing purpose but also production of a wide variety of precision members. For example, ink-jet technology is expected as a technology for production of precision members, most notably color filters, which substitutes for traditional technologies including lithography and allows enhancement of design flexibility and significant increase in productivity. However, neither pigment fine particles suitable for such a technology and fully adaptable to those requirements nor ink-jet inks containing such pigment fine particles are present yet.

From this background, pigments are required to be fined down so as to have particle diameters on the order of, for example, several tens of nanometers, and to be undergone such particle-diameter control that the distribution of their particle diameters approaches a monodisperse distribution. However, it is difficult to obtain such pigments by use of a general breakdown method (crushing method). This is because such a method requires great amounts of time and energy for crushing down pigments to nanometer-size particles, so it has low productivity, and besides, it limits pigments usable therein. In addition, it is known that, when too high energy is applied in the crushing method, an adverse effect referred to as overdispersion, such as a thickening phenomenon by re-aggregation, is caused.

Contrary to this, a build-up method in which particles are made to grow in a gas phase or a liquid phase has been studied. For example, methods of forming organic compound particles in a micro-chemical process are disclosed (see European Patent Publication No. 1516896 A1 and JP-A-2005-307154 (“JP-A” means unexamined published Japanese patent application)), and those methods make it possible to obtain fine particles with efficiency.

Particles pulverized to a diameter of tens of nanometers have advantages such as favorable transparency and color developing efficiency, but it is also known that the dispersion stability thereof often declines when the specific surface area increases (see Yuki Ganryo Handbook (Handbook of Organic Pigments), edited by Color Office, page 45). Proposed as a means for solving the problems was a production method of dissolving an organic pigment in an organic solvent in the presence of an alkali or acid, adding a polymerizable compound to the solution, obtaining a pigment fine particle dispersion by mixing the resulting solution with a poor solvent such as water, and polymerizing the polymerizable compound (JP-A-2004-43776). Also proposed is a method of performing the step of obtaining a pigment fine particle dispersion in a microchannel and heating the dispersion obtained in the step above in the presence of a polymerizable compound (JP-A-2007-39643).

However, both in the methods described in JP-A-2004-43776 and JP-A-2007-39643, the pigment dispersion containing a polymerizable compound and a polymerization initiator was subjected to polymerization reaction under heat in a conventional batchwise container. Inevitably by the methods, the polymer-processed pigment fine particles are exposed to change in conditions including concentration in the earlier and later stages of the polymerization processing, which in turn causes a problem of expansion of the molecular weight distribution of the polymer. It is generally known that the molecular weight of the pigment dispersant has a most favorable value and is difficult to obtain desired effects at a molecular weight larger or smaller than the value (e.g., Journal of Japan Society of Colour Material, 2006 (2) p.62), and it is needed to control the molecular weight of polymer for improving the dispersion stability of the pigment fine particles. The pigment fine particles production was carried out in a flow system in JP-A-2007-39643, but, because the polymerization step was carried out batchwise in a flask, the production method had problems of difficulty in scaling tip (for mass production) and thus increase in cost, in addition to the problems above.

As described above, there is no satisfactory method of producing an organic pigment fine particle dispersion having favorable dispersion stability, in particular an ultrafine particle dispersion, cost-effectively and reliably, and there remain many problems to be overcome.

Separately, it was reported that radical polymerization reaction in microchannel gave a polymer having a controlled molecular weight (Macromolecules, 2005, 38, 1159).

A method of producing flat irregular-shaped fine particles by emulsion polymerization is known (JP-B-3440197 (“JP-B” means examined Japanese patent publication)). A crosslinkable vinyl monomer is subjected to emulsion polymerization in an aqueous medium in the absence of water-insoluble organic solvent by using a water-soluble polymerization initiator, while vinyl polymer particles are used as seed particles. Also known is a method of producing fine particles by solidifying a dispersion phase of a liquid that solidifies in reaction by supplying into a continuous phase substantially immiscible therewith in a channel (JP-A-2005-194425). The former method is a method only for production of irregular-shaped particles and the latter method for production of fine particles having a particularly-shaped non-spherical cross section; thus, the shape is limited, and the size is in the micron order; and for that reason, there was a demand for a method of producing a fine particle structure in the smaller nanometer size level.

A method of producing a micro structure in a microreactor is known (JP-A-2007-90306). It is a method of producing a micro structure having a circular, oval, polygonal, cross-like or star-shaped cross-sectional shape, by supplying a fluid containing an energy ray-curing monomer and a polymerization initiator into a first channel, supplying a second liquid into a second channel formed to enclose the first channel, thus, allowing the solutions to become contact with each other at the point where the two channels are joined, and irradiating the first liquid with an energy ray. However, the structure has a larger size in the micron order, and there was an urgent need for development of a method of forming a structure in the smaller nanometer size level.

### SUMMARY OF THE INVENTION

The present invention resides in a method of producing a polymer-processed organic fine particle dispersion, comprising a step of: feeding an organic fine particle dispersion containing a polymerizable compound in a channel and polymerizing the polymerizable compound during the flow of the dispersion in the channel.

Further, the present invention resides in an ink-jet recording ink, comprising a polymer-processed organic pigment fine particle dispersion which is an aqueous dispersion produced by the method of producing as mentioned above.

Further, the present invention resides in a paint, comprising a polymer-processed organic pigment fine particle dispersion which is an aqueous dispersion produced by the method of producing as mentioned above.

Other and further features and advantages of the invention will appear more fully from the following description, appropriately referring to the accompanying drawings.

### BRIEF DESCRIPTION OF THE DRAWINGS

FIG. 1-1 is a plane view of a reactor which has a Y-shaped channel on one side.

FIG. 1-2 is a sectional view taken on line I-I of FIG. 1-1.

FIG. 2-1 is a vertical section view of a reactor which has a cylindrical tube-type channel in which a channel is provided to insert at one side thereof.

FIG. 2-2 is a sectional view taken on line IIa-IIa of FIG. 2-1.

FIG. 2-3 is a sectional view taken on line IIb-IIb of FIG. 2-1.

FIG. 3-1 is a plane view of a reactor which has Y-shaped channels on both sides.

FIG. 3-2 is a sectional view taken on line III-III of FIG. 3-1.

FIG. 4 is a vertical section view of one embodiment of a reactor which has a cylindrical tube-type channel in which channels are provided to insert at both sides thereof.

FIG. 5 is a plane cross section view illustrating one embodiment of a plane-type micro-reactor.

FIG. 6 is a plane cross section view illustrating another embodiment of a plane-type micro-reactor.

FIG. 7 is a plane cross section view illustrating still another embodiment of a plane-type micro-reactor.

FIG. 8 is an exploded perspective view showing an exploded state of one embodiment of a three-dimensional micro-reactor.

### DETAILED DESCRIPTION OF THE INVENTION

According to the present invention, there is provided the following means:

(1) A method of producing a polymer-processed organic fine particle dispersion, comprising a step of: feeding an organic fine particle dispersion containing a polymerizable compound in a channel and polymerizing the polymerizable compound during the flow of the dispersion in the channel.

(2) The method of producing a polymer-processed organic pigment fine particle dispersion according to the above item (1), wherein the volume average particle diameter (Mv) of organic fine particles is from 10 nm to 50 nm.

(3) The method of producing a polymer-processed organic pigment fine particle dispersion according to the above item (1) or (2), wherein the polymerizable compound is polymerized in a radical polymerization reaction.

(4) The method of producing a polymer-processed organic fine particle dispersion according to any one of the above items (1) to (3), wherein the polymerizable compound is polymerized in a radical polymerization reaction by using a water-soluble polymerization initiator.

(5) The method of producing a polymer-processed organic fine particle dispersion according to any one of the above items (1) to (4), wherein the polymerizable compound includes N-vinylpyrrolidone.

(6) The method of producing a polymer-processed organic fine particle dispersion according to any one of the above items (1) to (5), wherein the polymerizable compound includes one or more polymerizable surfactant.

(7) The method of producing a polymer-processed organic fine particle dispersion according to any one of the above items (1) to (6), wherein the equivalent diameter of the channel used in the polymerization step is 0.1 mm or more and 16 mm or less.

(8) The method of producing a polymer-processed organic fine particle dispersion according to any one of the above items (1) to (7), wherein the polymerization step is carried out at a temperature of 50° C. to 100° C.

(9) The method of producing a polymer-processed organic fine particle dispersion according to any one of the above items (1) to (8), wherein the organic fine particles to be polymer-processed are organic fine particles prepared by a build-up method.

(10) The method of producing a polymer-processed organic fine particle dispersion according to any one of the above items (1) to (9), wherein after preparation of the organic fine particle dispersion in the step of mixing a solution containing a dissolved organic compound with a precipitation medium and bringing them into contact with each other during flow in a microreactor apparatus, the organic pigment fine particle dispersion obtained is added with a polymerizable compound and subjected to polymerization processing.

(11) The method of producing a polymer-processed organic fine particle dispersion according to any one of the above items (1) to (10), wherein the precipitation medium precipitating the organic compound is an aqueous medium.

(12) The method of producing a polymer-processed organic fine particle dispersion according to any one of the above items (1) to (11), wherein the solution containing a dissolved organic compound is a solution obtained by dissolving the organic compound with an acid or alkali.

( 13) The method of producing a polymer-processed organic fine particle dispersion according to any one of the above items (9) to (12), wherein the organic fine particle dispersion containing a polymerizable compound is a dispersion obtained by adding a polymerizable compound to the solution containing a dissolved organic compound and adding a water-soluble radical polymerization initiator to the precipitation medium.

(14) The method of producing a polymer-processed organic fine particle dispersion according to any one of the above items (1) to (13), wherein, when the liquid stream of the solution containing a dissolved organic compound and the liquid stream of the precipitation medium are mixed as they are joined, at least one liquid stream is divided into multiple substreams, the center axis of at least one substream of the divided multiple substreams and the center axis of the other liquid stream are mixed as they are joined crosswise at a point in the junction region.

(15) The method of producing a polymer-processed organic fine particle dispersion according to the above item (14), wherein the multiple substreams are supplied through channels extending radially from the central junction region into the central junction region and are mixed as they are joined there.

(16) The method of producing a polymer-processed organic fine particle dispersion according to any one of the above items (10) to (15), wherein the step of precipitating the fine particles and the subsequent heating treatment step during the flow of the dispersion in the channel are performed under a series of liquid feedings by use of the microreactor apparatus.

(17) The method of producing a polymer-processed organic fine particle dispersion according to any one of the above items (1) to (16), wherein the organic fine particles are organic pigment fine particles.

(18) An ink-jet recording ink, comprising a polymer-processed organic pigment fine particle dispersion which is an aqueous dispersion produced by the method of producing according to any one of the above items (1) to (17).

(19) A paint, comprising a polymer-processed organic pigment fine particle dispersion which is an aqueous dispersion produced by the method of producing according to any one of the above items (1) to (18).

In the method of producing a polymer-processed organic fine particle dispersion of the present invention, an organic fine particle dispersion containing a polymerizable compound is polymerized during the flow of the dispersion in a channel. The organic fine particles used in the present invention are not particularly limited, but the volume average particle diameter (Mv) measured in the dispersion containing the fine particles by a dynamic light scattering method is preferably 100 nm or less, more preferably 50 nm or less. In the present invention, the particle diameter refers to a diameter of a particle. As to the monodispersibility of particles to be polymer-processed, a value (Mv/Mn) obtained by dividing a volume average particle diameter Mv by a number average particle diameter Mn may be expressed as an index. The value Mv/Mn is preferably 1.8 or less, more preferably 1.5 or less.

The organic fine particles used in the production method of the present invention are preferably formed with an organic compound that holds promise of manifesting size effect when it is fined down. Such an organic compound has no particular restrictions, and when examples of such an organic compound are classified by application, they include functional organic dye compounds (such as organic pigments, sensitizing dyes, photoelectric conversion dyes, optical recording dyes, image recording dyes and coloring dyes), organic electronic materials (such as charge transporting agents and nonlinear optical materials) and medical-related compounds (such as medicines, agricultural chemicals, analytical reagents, diagnostic products and dietary supplements). Of these compounds, charge transporting agents, organic pigments, optical recording dyes, image recording dyes and coloring dyes are preferable to the others, and organic dye compounds including optical recording dyes, image recording dyes, coloring dyes and the like are far preferred. When classification is made by structure, those compounds are not limited to single molecules, but they may be oligomers or polymers containing repeating units combined by the same or different molecular bindings in their respective molecular structures. In addition, they may be hybrid organic-inorganic or organic-metallic compounds.

Further, the fine particles obtained by the production method of the present invention are uniform in size. So, it becomes feasible to increase their solubility in solvents, lower the dissolution temperature thereof and shorten the time required for their dissolution. As a result, a desirable effect of preventing thermal decomposition of the organic compound from occurring in the dissolution process can be produced.

Hereinafter, specific examples of the charge transporting agent usable in the production method of the present invention will be described. However, the present invention is not limited thereto.

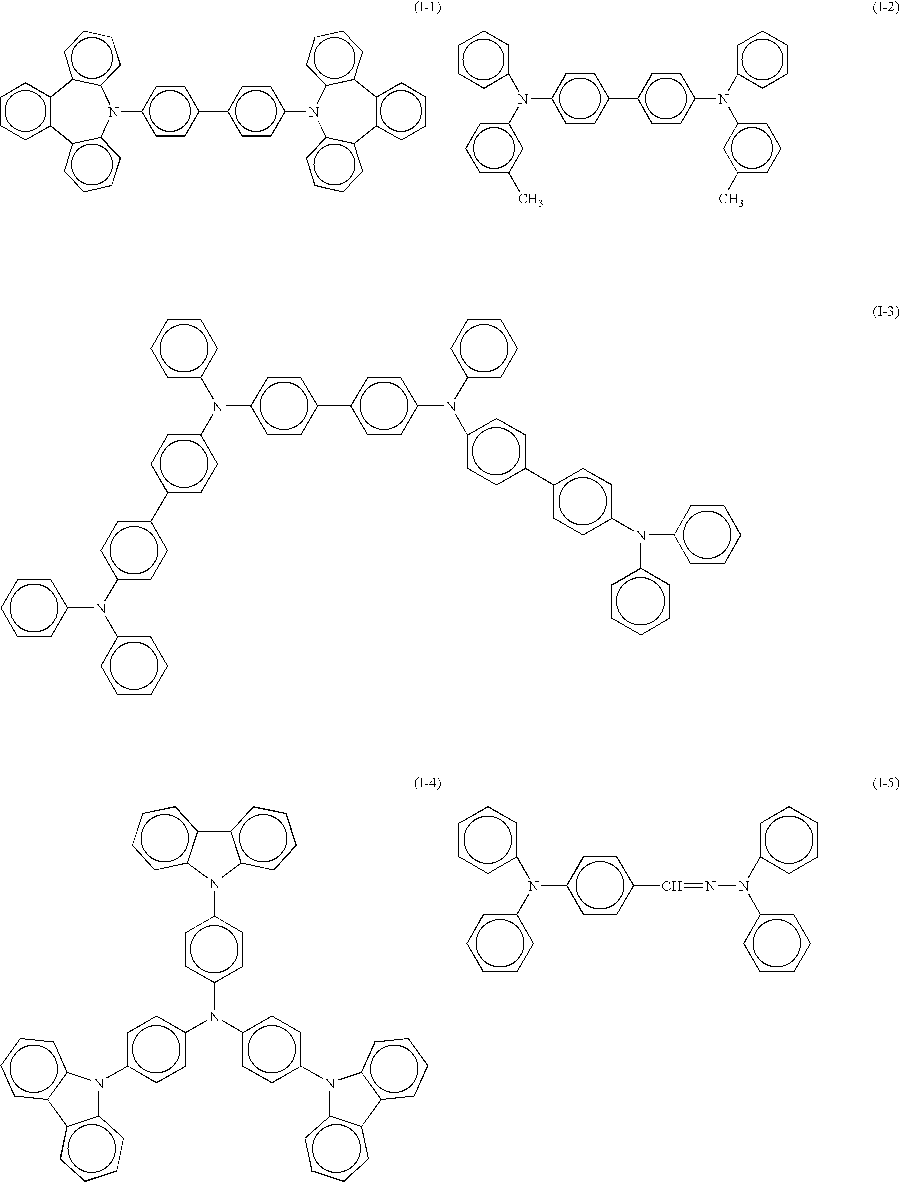

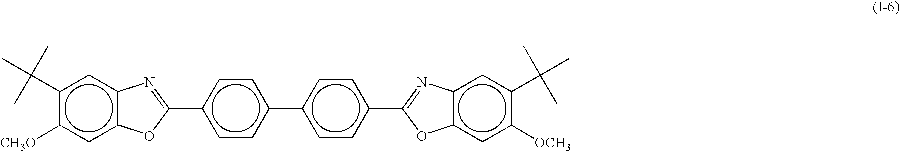

Hereinafter, specific examples of the optical recording dye usable in the production method of the present invention will be described. However, the present invention is not limited thereto.

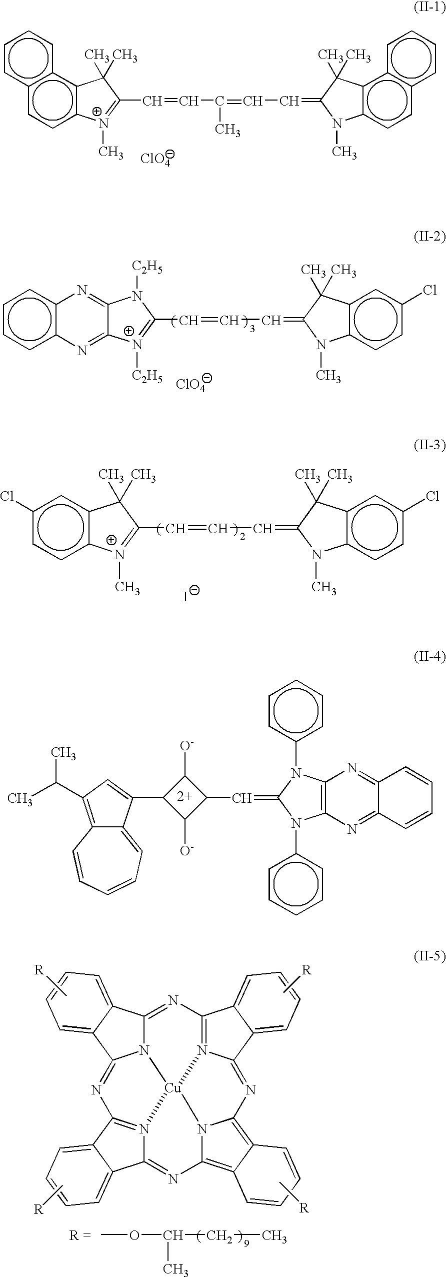

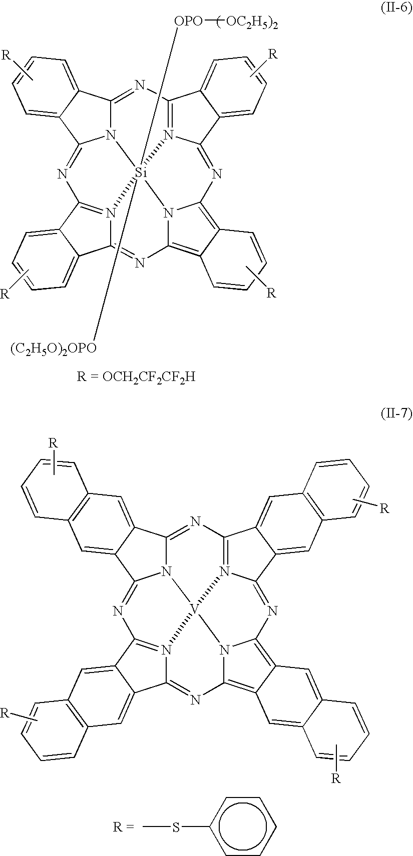

The organic pigment usable in the present invention is not limited in hue thereof. The organic pigment usable in the present invention may be a magenta pigment, a yellow pigment or a cyan pigment. Specifically, examples of the magenta pigment, the yellow pigment or the cyan pigment include perylene-compound pigments, perynone-compound pigments, quinacridone-compound pigments, quinacridonequinone-compound pigments, anthraquinone-compound pigments, anthanthorone-compound pigments, benzimidazolone-compound pigments, condensed disazo-compound pigments, disazo-compound pigments, azo-compound pigments, indanthrone-compound pigments, indanthrene-compound pigments, quinophthalone-compound pigments, quinoxalinedione-compound pigments, metal-complex azo-compound pigments, phthalocyanine-compound pigments, triarylcarbonium-compound pigments, dioxazine-compound pigments, aminoanthraquinione-compound pigments, diketopyrrolopyrrole-compound pigments, naphthol AS compound pigments, thioindigo-compound pigments, isoindoline-compound pigments, isoindolinone-compound pigments, pyranthrone-compound pigments, isoviolanthrone-compound pigments, and mixtures of any two or more thereof.

More specifically, examples of the organic pigment include perylene-compound pigments, such as C.I. Pigment Red 190 (C.I. No. 71140), C.I. Pigment Red 224 (C.I. No.71127), and C.I. Pigment Violet 29 (C.I. No.71129); perynone-compound pigments, such as C.I. Pigment Orange 43 (C.I. No.71105), and C.I. Pigment Red 194 (C.I. No.71100); quinacridone-compound pigments, such as C.I. Pigment Violet 19 (C.I. No.73900), C.I. Pigment Violet 42, C.I. Pigment Red 122 (C.I. No.73915), C.I. Pigment Red 192, C.I. Pigment Red 202 (C.I. No.73907), C.I. Pigment Red 207 (C.I. Nos. 73900 and 73906), and C.I. Pigment Red 209 (C.I. No.73905); quinacridonequinone-compound pigments, such as C.I. Pigment Red 206 (C.I. No. 73900/73920), C.I. Pigment Orange 48 (C.I. No.73900/73920), and C.I. Pigment Orange 49 (C.I. No.73900/73920); anthraquinone-compound pigments, such as C.I. Pigment Yellow 147 (C.I. No.60645); anthanthrone-compound pigments, such as C.I. Pigment Red 168 (C.I. No.59300); benzimidazolone-compound pigments, such as C.I. Pigment Brown 25 (C.I. No.12510), C.I. Pigment Violet 32 (C.I. No. 12517), C.I. Pigment Yellow 180 (C.I. No.21290), C.I. Pigment Yellow 181 (C.I. No.11777), C.I. Pigment Orange 62 (C.I. No.11775), and C.I. Pigment Red 185 (C.I. No.12516); condensed disazo-compound pigments, such as C.I. Pigment Yellow 93 (C.I. No. 20710), C.I. Pigment Yellow 94 (C.I. No.20038), C.I. Pigment Yellow 95 (C.I. No. 20034), C.I. Pigment Yellow 128 (C.I. No.20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No.20050), C.I. Pigment Red 144 (C.I. No. 20735), C.I. Pigment Red 166 (C.I. No.20730), C.I. Pigment Red 220 (C.I. No.20055), C.I. Pigment Red 221 (C.I. No.20065), C.I. Pigment Red 242 (C.I. No.20067), C.I. Pigment Red 248, C.I. Pigment Red 262, and C.I. Pigment Brown 23 (C.I. No.20060); disazo-compound pigments, such as C.I. Pigment Yellow 13 (C.I. No.21100), C.I. Pigment Yellow 83 (C.I. No.21108), and C.I. Pigment Yellow 188 (C.I. No.21094); azo-compound pigments, such as C.I. Pigment Red 187 (C.I. No. 12486), C.I. Pigment Red 170 (C.I. No.12475), C.I. Pigment Yellow 74 (C.I. No.11714), C.I. Pigment Red 48 (C.I. No.15865), C.I. Pigment Red 53 (C.I. No.15585), C.I. Pigment Orange 64 (C.I. No.12760), and C.I. Pigment Red 247 (C.I. No.15915); indanthrone-compound pigments, such as C.I. Pigment Blue 60 (C.I. No.69800); phthalocyanine-compound pigments, such as C.I. Pigment Green 7 (C.I. No.74260), C.I. Pigment Green 36 (C.I. No.74265), Pigment Green 37 (C.I. No.74255), Pigment Blue 16 (C.I. No.74100), C.I. Pigment Blue 75 (C.I. No.74160:2), and 15 (C.I. No.74160); triaryl carbonium-compound pigments, such as C.I. Pigment Blue 56 (C.I. No.42800), and C.I. Pigment Blue 61 (C.I. No.42765:1); dioxazine-compound pigments, such as C.I. Pigment Violet 23 (C.I. No.51319), and C.I. Pigment Violet 37 (C.I. No.51345); aminoanthraquinone-compound pigments, such as C.I. Pigment Red 177 (C.I. No.65300); diketopyrrolopyrrole-compound pigments, such as C.I. Pigment Red 254 (C.I. No. 56110), C.I. Pigment Red 255 (C.I. No.561050), C.I. Pigment Red 264, C.I. Pigment Red 272 (C.I. No.561150), C.I. Pigment Orange 71, and C.I. Pigment Orange 73; thioindigo-compound pigments, such as C.I. Pigment Red 88 (C.I. No.73312); isoindoline-compound pigments, such as C.I. Pigment Yellow 139 (C.I. No.56298), C.I. Pigment Orange 66 (C.I. No.48210); isoindolinone-compound pigments, such as C.I. Pigment Yellow 109 (C.I. No.56284), and C.I. Pigment Orange 61 (C.I. No. 11295); pyranthrone-compound pigments, such as C.I. Pigment Orange 40 (C.I. No. 59700), and C.I. Pigment Red 216 (C.I. No.59710); and isoviolanthrone-compound pigments, such as C.I. Pigment Violet 31 (C.I. No.60010).

Preferred pigments are quinacridone organic pigments, diketopyrrolopyrrole organic pigments, condensed disazo organic pigments, and phthalocyanine organic pigments, and particularly preferred pigments are quinacridone organic pigments, condensed disazo organic pigments, and phthalocyanine organic pigments.

Examples of an organic dye compound usable for coloring purpose in the production method of the present invention include hydrophobic dyes, and more specifically, reactive dyes, azoic dyes, fluorescent dyes, disperse dyes, styrene dyes, acidic dyes, metal-containing dyes, acidic mordant dyes, direct dyes, cationic dyes, basic dyes, sulfide dyes and oil-soluble dyes.

Hereinafter, specific examples of the coloring dye usable in the production method of the present invention will be described. However, the present invention is not limited thereto.

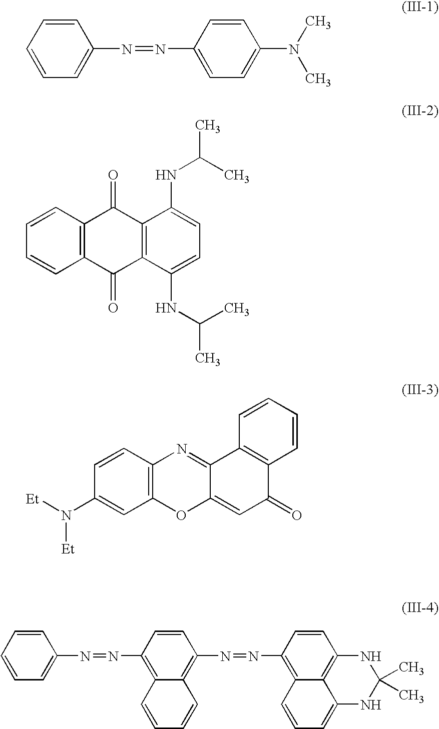

The method for preparing an organic fine particle dispersion for use in the present invention is not limited to particular ones, and it can be chosen from a build-up method, a crushing method or the like as appropriate. And it is advantageous for the organic fine particle dispersion to be prepared by a build-up method. The build-tip method will be described in detail below. Although the dispersion medium also has no particular limitation and a liquid hindering the fine particle from polymerization-processing can be chosen as appropriate. Examples of a preferred dispersion medium include water (which may contain a salt), alcohol compounds (e.g., methanol, ethanol, ethylene glycol monoether), esters (e.g., ethyl acetate, ethylene glycol monoester), ketones (e.g., acetone, 2-butanone), amides (e.g., N,N-dimethylformamide, N,N-dimethylacetamide, N-methylpyrrolidone), dimethyl sulfoxide, and mixtures of two or more of the above-recited ones. In particular, liquids containing water as a main component (those containing at least 50 vol % of water) are preferred.

The concentration of the organic fine particles polymerization-processed in the present invention is preferably in the range of 0.02 mass % to 20 mass %, more preferably in the range of 0.1 mass % to 10 mass %.

The polymerization method used for the method of producing a polymer-processed organic fine particle dispersion of the present invention is not particularly limited, if it is a method allowing polymerization in the organic fine particle dispersion while it flows in channel, and the polymerization may be chosen from radical polymerization, condensation polymerization, cationic polymerization, anionic polymerization and the like as appropriate, but radical polymerization by using a polymerization initiator is preferable. The means for initiating polymerization reaction during radical polymerization is not particularly limited, but heating is preferable.

In the production method of the present invention, the polymerizable compound (monomer) used in polymer processing of the organic fine particles by radical polymerization will be described.

As a radical polymerizable compound suitable as the polymerizable compound, both water-soluble and water-insoluble polymerizable compounds are usable, and those having C═C bonds are preferred. Examples of such polymerizable compounds include (meth)acrylic acid esters (such as methyl acrylate, ethyl acrylate, butyl acrylate and benzyl acrylate), styrenes (such as styrene and o-methylstyrene), vinyl esters (such as vinyl acetate and vinyl propionate), N-vinylamides (such as N-vinylpyrrolidone), (meth)acrylic acid amides, vinyl ethers (such as vinyl methyl ether, vinyl isobutyl ether and vinyl phenyl ether), and (meth)acrylonitrile.

Further, a water-soluble monomer having an anionic group such as a sulfonic group, a phosphoric group, or a carboxylic group is also used. An example thereof includes: a monomer having a carboxyl group such as acrylic acid, methacrylic acid, maleic acid, fumaric acid, itaconic acid, or p-vinyl benzoic acid; or an alkali metal salt, an alkaline earth metal salt, an ammonium salt, an amine salt or the like of the monomer. In addition, specific examples thereof include: styrene sulfonic acid, sodium styrene sulfonate, 2-acrylamide-2-methylpropane sulfonic acid, 2-hydroxy methyl methacryloyl phosphate, 2-hydroxy ethyl methacryloyl phosphate, and 3-chloro-2-hydroxy propyl methacryloyl phosphate. The monomers may be used alone or in combination.

The compounds preferred as polymerizable compounds usable in the present invention are (meth)acrylic acid esters, styrenes, vinyl ethers and N-vinylamides. Among them, N-vinylpyrrolidone is especially preferred.

The polymerizable compound used in the present invention may be a compound having two or more polymerizable groups per molecule. Examples of such a compound include divinylbenzene, ethylene glycol diacrylate, diallyl ether and divinyl ether.

In order to further improve the uniform dispersibility and temporal stability (storage stability) of organic fine particles, the content of a polymerizable compound is preferably from 0.1 to 1,000 parts by mass, more preferably from 1 to 500 parts by mass, particularly preferably from 10 to 250 parts by mass, per 100 parts by mass of the organic compound. When the content is too low, there may be cases where the dispersion stability of organic fine particles after the polymer processing shows no improvement. When a dispersing agent is incorporated in addition to the polymerizable compound, the content of the dispersing agent is preferably adjusted so that the total content of them is within the range specified above.

The polymerization initiator to be used, though not particularly limited so long as it can polymerize the polymerizable compound used, is preferably a water-soluble or oil-soluble azo polymerization initiator, a macromolecular azo polymerization initiator, an inorganic salt represented by a persulfate, or a peroxide. Of these initiators, a water-soluble azo polymerization initiator, a macromolecular azo polymerization initiator and an inorganic salt are more preferred, an inorganic salt and a macromolecular azo polymerization initiator are still more preferred, and a macromolecular azo polymerization initiator is especially preferred. Examples of an inorganic salt include ammonium persulfate, potassium persulfate and sodium persulfate, examples of a peroxide include hydrogen peroxide, t-butyl hydroperoxide and benzoyl peroxide (BPO), examples of an oil-soluble azo polymerization initiator include 2,2′-azobisisobutyronitrile (AIBN), 2,2′-azobis(4-methoxy-2,4-dimethylvaleronitrile), 2,2′-azobis(2,4-dimethylvaleronitrile) (V-70, trade name, a product of Wako Pure Chemical Industries, Ltd.), dimethyl 2,2′-azobis(2-methylpropionate) (V-65, trade name, a product of Wako Pure Chemical Industries, Ltd.), 2,2′-azobis(2-methylbutyronitrile) (V-601, trade name, a product of Wako Pure Chemical Industries, Ltd.), 1,1′-azobis(cyclohexane-1-carbonitrile) (V-59, trade name, a product of Wako Pure Chemical Industries, Ltd.), 2,2′-azobis[N-(2-propenyl)-2-methylpropionamide] (V-40, trade name, a product of Wako Pure Chemical Industries, Ltd.), 1-[(cyano-1-methylethyl)azo]formamide (VF-096, trade name, a product of Wako Pure Chemical Industries, Ltd.), 2,2′-azobis(N-butyl-2-methylpropionamide) (V-30, trade name, a product of Wako Pure Chemical Industries, Ltd.), 2,2′-azo(N-cyclohexyl-2-methylpropionamide) (VAm-110, trade name, a product of Wako Pure Chemical Industries, Ltd.) and VAm-111 (trade name, a product of Wako Pure Chemical Industries, Ltd.), examples of a water-soluble azo polymerization initiator include 2,2′-azobis[2-(2-imidazoline-2-yl)propane] dihydrochloride, 2,2′-azobis[2-(2-imidazoline-2-yl)propane] disulfate dihydrate (VA-044, trade name, a product of Wako Pure Chemical Industries, Ltd.), 2,2′-azobis(2-methylpropionamidine) dihydrochloride (VA-046B, trade name, a product of Wako Pure Chemical Industries, Ltd.), 2,2′-azobis[N-(2-caroxyethyl)-2-methylpropionamidine] tetrahydrate (V-50, trade name, a product of Wako Pure Chemical Industries, Ltd.), 2,2′-azobis {2-[1-(2-hydroxyethyl)-2-imidazoline-2-yl]propane} dihydrochloride (VA-057, trade name, a product of Wako Pure Chemical Industries, Ltd.), 2,2′-azobis[2-(2-imidazoline-2-yl)propane] (VA-060, trade name, a product of Wako Pure Chemical Industries, Ltd.), 2,2′-azobis(1-imino-1-pyrrolidino-2-ethylpropane) dihydrochloride (VA-061, trade name, a product of Wako Pure Chemical Industries, Ltd.), 2,2′-azobisf{2-methyl-N-[1,1-bis(hydroxymethyl)-2-hydroxyethyl]propionamide} (VA-067, trade name, a product of Wako Pure Chemical Industries, Ltd.), 2,2′-azobis[2-methyl-N-(2-hydroxyethyl)propionamide] (VA-080, trade name, a product of Wako Pure Chemical Industries, Ltd.), VA-086 (trade name, a product of Wako Pure Chemical Industries, Ltd.), 2,2′-azobis(2-amidinopropane) dihydrochloride, 2,2′-azobis(2-N-benzylaimidinopropane) dihydrochloride and 2,2′-azobis[2-N-(2-hydroxyethyl)amidinopropane] dihydrochloride, and examples of a macromolecular azo polymerization initiator include polydimethylsiloxane unit-containing macromolecular azo polymerization initiators, such as VPS-0501 (polysiloxane unit molecular weight: about 5,000) and VPS-1001 (polysiloxane unit molecular weight: about 10,000), trade names, products of Wako Pure Chemical Industries, Ltd.; and polyethylene glycol unit-containing macromolecular azo polymerization initiators, such as VPE-0201 (polyethylene glycol unit molecular weight: about 2,000), VPE-0401 (polyethylene glycol unit molecular weight: about 4,000) and VPE-0601 (polyethylene glycol unit molecular weight: about 6,000), trade names, products of Wako Pure Chemical Industries, Ltd. Various kinds of water-soluble azo polymerization initiators, oil-soluble azo polymerization initiators and macromolecular azo polymerization initiators are described, e.g., in the website of Wako Pure Chemical Industries, Ltd. (www.wako-com.co.jp) together with their individual structures and 10 hour half-life decomposition temperatures, and available from Wako. The amount of a polymerization initiator used is not particular limited, but preferably from 0.1 to 30 mass %, more preferably from 1 to 20 mass %, particularly preferably from 2 to 10 mass %, with respect to the total monomer component.

In the production method of the present invention, use of a water-soluble polymerization initiator is preferable.

The polymerization processing is carried out while the dispersion flows in channel in the present invention. The diameter of the channel in the polymerization region is not particularly limited, but the channel preferably has an equivalent diameter in the range of 0.1 mm or more and 16 mm or less. Preferably, a channel having a suitable diameter is selected according to applications, because there are cases where the liquid to be polymerized per unit period is limited or the polymerization period is too short.

In the production method according to the present invention, especially when heat-initiated radical polymerization reaction is used, the advantage of carrying out the polymerization reaction in channel is significant. Reduction of the channel diameter leads to accelerated heat exchange, advantageously enabling uniform heating of the liquid at a constant temperature for a constant period, reduction of the molecular weight distribution of the polymer, and uniform processing of all fine particles without irregularity. If heat-initiated radical polymerization reaction is used, a narrow-diameter channel for accelerated heat exchange may be connected to a downstream large-diameter channel for assuring sufficient heating time, and such a method is one of preferred methods. The flow rate and the channel length of the polymerization (heating) region are not particularly limited and adjusted to a preferable value appropriately. However, the combination of the diameter, flow rate, and channel length in polymerization region is preferably selected to assure a liquid heating time of 10 seconds or longer. Excessive short heating time may lead to decrease in the conversion rate of the polymerizable compound. There is no particular maximum heating time, but the heating time is preferably 5 hours or less, from the viewpoints of favorable particle diameter and cost. The heating time is more preferably 15 seconds or more and 3 hours or less, more preferably 20 seconds or more and 2.5 hours or less, and most preferably 60 seconds or more and 2.5 hours or less. The polymerization temperature is preferably 40° C. to 100° C., particularly preferably 60° C. to 90° C.

Polymerization of a polymerizable compound in a fine particle dispersion previously prepared while it flows in channel, as in the present invention, has an advantage that the polymer can be adsorbed on the organic fine particle surface effectively (giving a stabilized and low-viscosity dispersion), compared to addition of the polymer. In addition, polymers not commercially available and those not soluble in water or organic solvent can also be used, as the corresponding monomers are polymerized. Polymerization under flow in channel also allows polymerization under uniform condition, even when the polymerization is carried out in a batch container. It results in reduction of molecular weight distribution, and also provides unexpected advantages such as favorable dispersion stability effective with a smaller amount of polymer (i.e., improvement both in dispersion stability and low viscosity), resistance to inhibition by oxygen because the polymerization is carried out in a closed space during radical polymerization, and reduction in size of the facility for mass production.

The term “dispersion” as used in the present invention refers to a composition prepared by dispersing given polymer-processed fine particles into a medium, and the composition has no particular restriction on its state. So, it is intended to include a liquid composition (dispersion liquid), a paste composition and a solid composition. In the organic fine particle dispersion produced by the production method of the present invention, the content of the polymer-processed organic fine particles, though not particularly limited, is preferably from 0.1 to 50% by mass, more preferably from 0.5 to 25% by mass.

The production method of the present invention is outstanding for resolution of a dispersion-stability problem emerging as organic fine particles are reduced in size, and suitable as a method of providing a dispersion liquid which can satisfy both transparency (i.e., smallness of particle diameter) and dispersion stability (a property of resisting changes in liquid viscosity and particle diameter even after a lapse of time).

The organic fine particle dispersion for use in the present invention is preferably a dispersion prepared by build-up method. In the present invention, the build-up method is defined as a method of forming nanometer-size organic pigment particles from an organic compound or an organic compound precursor dissolved in a solvent (molecular dispersion) through chemical operation and processing without requiring any additional fining operation, such as a crushing operation. Although the build-up method is roughly classified into a vapor-phase method and a liquid-phase method, it is preferable in the present invention that the fine particles are formed according to a liquid-phase method.

The organic compounds usable as a raw material of the organic fine particles in the production method of the present invention are preferably compounds that have low solubility in precipitation solvents and are isolated from their solutions in the form of liquids or solids when mixed with the precipitation solvents, more preferably those separating out in the form of solids.

In the production method of the present invention, a polymerizable compound (monomer) may be used as a raw material for the organic fine particles synthesized by the build-up method. More specifically, in an embodiment of the production method of the present invention, a dispersion of a precursor monomer of organic fine particles (including a case where the monomer to be formed is in a liquid state, namely a case of emulsion) is prepared by the build-up method, and then the precursor monomer of organic fine particles is polymerized by polymerization operations and converted into polymer fine particles. This polymerization process of the precursor monomer of organic fine particles and a process for polymerizing a polymerizable compound may be carried out successively or simultaneously. According to this method, organic fine particles covered with another kind of polymer (a polymer of a polymerizable compound), such as fine particles of core-shell type, can be obtained.

The organic fine particle dispersion for use in the present invention is preferably a dispersion containing organic fine particles prepared by precipitation by coprecipitation method. Especially when the organic fine particles are organic pigment fine particles, the coprecipitation method is used favorably. The coprecipitation method, as used in the present invention, is defined to be a method of precipitating organic fine particles by bringing a solution (molecular dispersion) of an organic compound dissolved in a solvent (hereinafter, the solvent dissolving the organic compound will be referred to as “good solvent”) into contact with a poor solvent (e.g., aqueous medium) in the presence of a dispersant and/or a surfactant. Sometimes the method which, though based on the coprecipitation method, dispenses with a dispersing agent in precipitating fine particles is referred specifically to as a reprecipitation method in distinction from the coprecipitation method. For details of the reprecipitation method, JP-A-2004-91560 or the like can be referred to. For details of the coprecipitation method, on the other hand, JP-A-2003-026972 or the like can be referred to.

In the coprecipitation method of the production method of the present invention, an organic compound solution and a precipitation solvent are brought into contact with each other. The organic compound solution used then is a uniform solution in a good solvent. Addition of a suspension leads to generation of organic fine particles having increased particle diameter or expanded particle distribution. In the present invention, the wording “homogeneously dissolved” means a solution in which turbidity (muddiness) is hardly observed when the solution is observed under visible light. In the present invention, a solution obtained by filtration through a micro-filter having pores of 1 μm or less in diameter, or a solution which does not contain any substance remaining after the solution is filtrated through a filter having pores of 1 μm or less in diameter, is defined as a homogeneously dissolved solution (or a homogeneous solution).

The good solvent, which may vary according to the organic compound used, is preferably a polar solvent, and examples thereof include fluorinated alcohols (such as 2,2,3,3-tetrafluoro-1-propanol), amide solvents (such as dimethylformamide, dimethylacetamide, N-methylpyrrolidone and 1,3-dimethyl-2-imidazolidinone), carboxylic acid solvents (such as formic acid and acetic acid), sulfonic acid solvents (such as methanesulfonic acid), sulfur-containing solvents (such as dimethylsulfoxide and sulfolane), ether solvents (such as tetrahydrofuran), halogenated solvents (such as chloroform and dichloromethane), ionic liquids (such as 1-butyl-3-methylimidazolium tetrafluoroborate) and the like. Use of dimethylformamide, dimethylacetamide, N-methylpyrrolidone or dimethylsulfoxide is preferable, and use of dimethylacetamide, N-methylpyrrolidone or dimethylsulfoxide is more preferable. These good solvents may be used alone or as a mixture. An acid or alkali, for example, may be added for solubilization as needed.

The amount of the good solvent to be used is not particularly limited, if it is an amount allowing uniform solubilization of the organic compound, but preferably 10 to 500 times, preferably 20 to 100 times, larger by weight than the organic compound.

Next, a precipitation solvent brought into contact with a solution of an organic compound (hereinafter referred simply to as “a precipitation solvent”, too) is described. Since the kind of a precipitation solvent to be used depends on the kinds of the good solvent and the organic compound used in combination therewith, and the like, it is difficult to choose only the precipitation solvent by itself. However, the precipitation solvent is preferably a poor solvent for the organic compound dissolved in a good solvent and the solubility of the organic compound therein is preferably 0.1 or less.

The combination of a good solvent and a precipitation solvent is preferably a combination formed of a solvent chosen as the good solvent in which the organic compound has solubility of 1 or more and a solvent chosen as the precipitation solvent in which the organic compound has solubility of 0.1 or less (the term “solubility” as used herein is defined as the concentration of a solute in a saturated solution and expressed in amount (number of grams) of a solute in 100 g of the solution).

It is preferred that the precipitation solvent at least be partially diffusible into a good solvent. The expression “at least be partially diffusible” as used in the present invention means that, when both solvents are stirred vigorously in a beaker and then allowed to stand for 24 hours or more, the proportion of the precipitation solvent dissolving in the good solvent is 10 mass % or more. At this time, it is preferable that the precipitation solvent is in a homogeneously dissolved state and neither precipitates nor deposits are formed. In the production method of the present invention, as mentioned above, the precipitation solvent used has a compatibility with the good solvent to such an extent that the proportion of the precipitation solvent homogeneously mixed in the good solvent is 10 mass % or more. However, it is preferable that the precipitation solvent has a compatibility of such an extent that the proportion of the precipitation solvent homogeneously mixable in the good solvent is 50 mass % or more, and it is more preferable that the precipitation solvent has a compatibility of such an extent that the proportion of the precipitation solvent homogeneously mixable in the good solvent is from 100 mass % to infinity.

As to the combination of a good solvent and a precipitation solvent, when the good solvent is, e.g., a halogen-containing solvent, examples of a solvent capable of functioning as the precipitation solvent include hydrocarbon solvents (such as n-hexane and toluene) and ester solvents (such as ethyl acetate).

Depending on the good solvent used in combination, a solvent suitable as the precipitation solvent is an aqueous medium, an alcohol solvent or a hydrocarbon solvent.

Those precipitation solvents may be used alone or as a mixture of two or more thereof. To the organic compound solution and the precipitation solvent, inorganic or organic salts, acids, alkalis or the like may further be added, if needed.

When the organic fine particles to be precipitated are fine particles of organic pigment, it is preferable that an aprotic polar solvent (such as dimethyl sulfoxide, N,N-dimethylformamide or N-methylpyrrolidone, most notably dimethyl sulfoxide) is used as the good solvent and an aqueous medium is used as the precipitation solvent. In addition, it is preferred that an alkali or acid be added to the good solvent for the purpose of dissolving the organic compound to form organic fine particles. Whether dissolution of the organic compound is carried out under an acidic condition or alkaline condition is chosen depending on which condition allows more homogeneous dissolution of the organic compound. In general, when the organic compound contains an alkali-dissociable group in its molecule, the alkaline condition can be chosen; while, when the organic compound contains in its molecule no alkali-dissociable group but many nitrogen atoms susceptible to protonation, the acidic condition can be chosen. In the present production method, it is advantageous for the dissolution to be performed on condition that an alkali is added to the greatest extent practicable. In general, in the case of the organic compound having in the molecule thereof a group dissociative under alkaline, the alkaline medium is used, and in the case of the organic compound having no group dissociative under alkaline and having in the molecule thereof many nitrogen atoms, to which protons easily adhere, the acidic medium is used. For example, quinacridone-, diketopyrrolopyrrole-, and condensed disazo-compound pigments can be dissolved in the alkaline medium more homogenously, and a phthalocyanine-compound pigment can be dissolved in the acidic medium more homogenously. It is especially preferable to apply the producing method of the present invention to cases where organic compound solutions can be prepared by dissolving organic compounds into alkalis. In the case of using acids for dissolution of organic compounds, there are restrictions on usable reactors because metallic apparatus susceptible to corrosion is difficult to use under usual conditions.

Examples of a base that can be used in the case that the pigment is dissolved in alkaline medium, include inorganic bases, such as sodium hydroxide, potassium hydroxide, calcium hydroxide, and barium hydroxide; and organic bases, such as trialkylamine, diazabicycloundecene (DBU), metal alkoxides (NaOCH₃, KOC₂H₅), tetraalkylammonium methoxide (tetramethylammonium methoxide) and tetraalkylammonium hydroxide (tetramethylammonium hydroxide). Among these, inorganic bases are preferable.

The amount of the base to be used is not particularly limited, as long as the base in the amount can make the organic compound be dissolved homogeneously. In the case of the inorganic base, the amount thereof is preferably from 1.0 to 30 mole equivalents, more preferably from 2.0 to 25 mole equivalents, and further preferably from 3.0 to 20 mole equivalents, to the organic compound. In the case of the organic base, the amount thereof is preferably from 0.4 to 20 mole equivalents, more preferably from 1.0 to 20 mole equivalents, and further preferably from 1.0 to 10 mole equivalents, to the organic compound.

Examples of an acid to be used in the case that the organic compound is dissolved in the acidic medium, include inorganic acids, such as sulfuric acid, hydrochloric acid, and phosphoric acid; and organic acids, such as acetic acid, trifluoroacetic acid, oxalic acid, methanesulfonic acid, and trifluoromethanesulfonic acid. Among these, the inorganic acids are preferable, and sulfuric acid is especially preferable.

The amount of the acid to be used is riot particularly limited. In many cases, the acid is used in a larger or more excessive amount than the base. Regardless the kind of the acid being an inorganic acid or an organic acid, the amount of the acid to be used is preferably from 3 to 500 mole equivalents, more preferably from 10 to 500 mole equivalents, and further preferably from 10 to 100 mole equivalents, to the organic compound.

Although the mixing ratio between an organic compound solution and a precipitation solvent varies depending on the kind of the organic compound to be formed into fine particles, the desired fine particle size and the like, the precipitation solvent/organic compound solution ratio (by mass) is preferably from 0.01 to 100, more preferably from 0.05 to 10.

In the present invention, the aqueous medium is water alone or a mixed solvent of water and a water-soluble organic solvent. The organic solvents is preferably used, when (a) water alone is not sufficient for uniform solubilization of the organic compound and the dispersing agent, (b) water alone is not sufficient for obtaining a viscosity suitable for flow in channel, or (c) addition of an organic solvent is desired for generation of laminar flow. In many cases, an aqueous medium containing an added water-soluble organic solvent can dissolve the organic compound and others uniformly.

Examples of the organic solvent to be added include polyvalent alcohol compound solvents such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivative, glycerol and trimethylolpropane; polyvalent alcohol lower monoalkylether compound solvents such as ethylene glycol monomethyl (or ethyl) ether, diethylene glycol monomethyl (or ethyl) ether and triethylene glycol monoethyl (or butyl) ether; polyether compound solvents such as ethylene glycol dimethylether (monoglyme), diethylene glycol dimethylether (diglyme) and triethylene glycol dimethylether (triglyme); amide compound solvents such as dimethylformamide, dimethylacetamide, 2-pyrrolidone, N-methyl-2-pyrrolidone, 1,3-dimethyl-2-imidazolidinone, urea and tetramethyl urea; sulfur-containing compound solvents such as sulfolane, dimethylsulfoxide and 3-sulfolene; multifunctional compound solvents such as diacetone alcohol and diethanolamine; carboxylic acid compound solvents such as acetic acid, maleic acid, docosahexaenoic acid, trichloroacetic acid and trifluoroacetic acid; sulfonate compound solvents such as methanesulfonic acid and trifluorosulfonic acid; and the like. These solvents may be used as a mixture of two or more.

The temperature when the organic fine particles are precipitated is desirably in the range that prohibits solidification or vaporization of the solvent, and preferably −20 to 90° C., more preferably 0 to 50° C. It is particularly preferably 5 to 15° C.

The dispersing agent or surfactant used in the coprecipitation method in the production method of the present invention is preferably a compound having functions to (1) form fine particles as it is adsorbed on the precipitated organic fine particle surface, and thus, (2) prevent reaggregation of these particles, and preferably an anionic, cationic, ampholytic, nonionic surfactant or polymer dispersing agent. These dispersing agents may be used alone or in combination.

Examples of the anionic dispersing agent (anionic surfactant) include N-acyl-N-alkyltaurine salts, fatty acid salts, alkylsulfates, alkylbenzenesulfonates, alkylnaphthalenesulfonates, dialkylsulfosuccinates, alkylphosphates, naphthalenesulfonic acid/formalin condensates, and polyoxyethylenealkylsulfates. These anionic dispersing agents may be used alone or in combination of two or more thereof.

Examples of the cationic dispersing agent (cationic surfactant) include quaternary ammonium salts, alkoxylated polyamines, aliphatic amine polyglycol ethers, aliphatic amines, diamines and polyamines derived from aliphatic amine and aliphatic alcohol, imidazolines derived from aliphatic acid, and salts of these cationic substances. These cationic dispersing agents may be used alone or in combination of two or more thereof.

The amphoteric dispersing agent is a dispersing agent having, in the molecule thereof, an anionic group moiety which the anionic dispersing agent has in the molecule, and a cationic group moiety which the cationic dispersing agent has in the molecule.

Examples of the nonionic dispersing agents (nonionic surfactant) include polyoxyethylenealkyl ethers, polyoxyethylenealkylaryl ethers, polyoxyethylene fatty acid esters, sorbitan fatty acid esters, polyoxyethylenesorbitan fatty acid esters, polyoxyethylenealkylamines, and glycerin fatty acid esters. Among these, polyoxyethylenealkylaryl ethers are preferable. These nonionic dispersing agents may be used alone or in combination of two or more thereof.

Examples of the polymer dispersing agent include polyvinyl pyrrolidone, polyvinyl alcohol, polyvinyl methyl ether, polyethylene oxide, polyethylene glycol, polypropylene glycol, polyacrylamide, vinyl alcohol/vinyl acetate copolymer, partial-formal products of polyvinyl alcohol, partial-butyral products of polyvinyl alcohol, vinylpyrrolidone/vinyl acetate copolymer, polyethylene oxide/propylene oxide block copolymer, polyacrylates, polyvinyl sulfates, poly(4-vinylpyridine) salts, polyamides, polyallylamine salts, condensed naphthalenesulfonates, styrene/acrylate copolymers, styrene/methacrylate copolymers, acrylic ester/acrylate copolymers, acrylic ester/methacrylic copolymers, methacrylic ester/acrylate copolymers, methacrylic ester/methacrylate copolymers, styrene/itaconate copolymers, itaconic ester/itaconate copolymers, vinylnaphthalene/acrylate copolymers, vinylnaphthalene/methacrylate copolymers, vinylnaphthalene/itaconate copolymers, cellulose derivatives, and starch derivatives. Besides, natural polymers can be used, examples of which include alginates, gelatin, albumin, casein, arabic gum, tragacanth gum, and ligninsulfonates.

Of the high molecular compounds recited above, polyvinyl pyrrolidone, polyvinyl alcohol, polyvinyl methyl ether, polyethylene oxide, polyethylene glycol, styrene/acrylate copolymers, styrene/methacrylate copolymers, acrylic ester/acrylate copolymers, acrylic ester/methacrylate copolymers, methacrylic ester/acrylate copolymers, and methacrylic ester/methacrylate copolymers are preferable.

Among all of these polymers, polyvinyl pyrrolidone is most preferred. Those high molecular compounds can be used alone or as combinations of two or more thereof.

When the polymer dispersing agent used in the production method of the present invention is a copolymer, the copolymer may be a block copolymer having some segments. In general, block copolymers having polyacrylic, polymethacrylic, polyoxyethylene, polyoxyalkylene or polystyrene segments and addition polymer or condensation polymer segments are known. In particular, amphipathic polymers including combinations of the same kind or different kinds of hydrophobic blocks and hydrophilic blocks are far preferred. Although no limits are imposed on the numbers of hydrophilic blocks and hydrophilic blocks to be combined, the block copolymer contains at least one kind of hydrophilic block and at least one kind of hydrophobic block. Examples of functional groups contained in a hydrophilic block include carboxylic acid groups, sulfonic acid groups, phosphoric acid groups, hydroxyl groups and alkylene oxides. The hydrophilic block preferably contains at least one kind of groups chosen from the groups recited above. Of those functional groups, carboxylic acid groups, sulfonic acid groups and hydroxyl groups are preferable to the others, carboxylic acid groups and hydroxyl groups are preferable to sulfonic acid groups, and carboxylic acid groups are especially preferred. In this way, a role of adsorption sites for organic fine particles and a function of strengthening the dispersion stability through steric repulsion and/or electrostatic repulsion can be imparted to the dispersing agent. These block copolymers may be used alone or as combinations of two or more thereof. In the present invention, it is preferred that at least one kind of polymerizable compound and at least one kind of block copolymer be used in combination. By such a combined use, stronger fixation becomes feasible at the time of formation of organic compound fine particles, and significant improvement in dispersion stability can be expected.

By using a surfactant having a polymerizable group on the occasion when coprecipitation is carried out, the surfactant can deriver both a function of controlling particle sizes at the time of precipitation of particles and a function as a polymerizable compound which becomes a raw material of polymer for retention of dispersion stability, and can be favorably used in the present method for producing an organic fine particle dispersion liquid. Examples of such a surfactant include compounds each having both an α,β-ethylenic unsaturated group, such as a vinyl group, an allyl group, a propenyl group or a (meth)acryloyl group, and a group capable of causing ionic dissociation, such as a sulfonic group or its salt, or a hydrophilic group such as an alkyleneoxy group. These compounds are generally used for emulsion polymerization, and they are anionic or nonionic surfactants having at least one radical-polymerizable unsaturated bond per molecule.

As the polymerizable compound in the method of producing an organic fine particle dispersion of the present invention, such polymerizable surfactants may be used alone, or as combinations of different ones, or in combination with polymerizable compounds other than themselves. Examples of a polymerizable surfactant preferably used in the present invention include various kinds of polymerizable surfactants available from Kao Corporation, Sanyo Chemical Industries, Ltd., DAI-ICHI KOGYO SEIYAKU CO., LTD., ADEKA CORPORATION, Nippon Nyukazai Co., Ltd., NOF CORPORATION, and the like, and more specifically, those recited in Biryushi Funtai no Saisentan Gijutsu (which might be literally translated “Leading-edge Technology of Fine Particles and Powder”), Chap. 1-3 entitled “Hanno Nyukazai wo Mochiiru Biryushi Sekkei” (which might be literally translated “Fine-Particle Design Using Reactive Emulsifier”), pp. 23-31, CMC Publishing Co., Ltd. (2000), and the like.

Hereinafter, specific examples of the polymerizable surfactant usable in the production miethod of the present invention will be described. However, the present invention is not limited thereto.

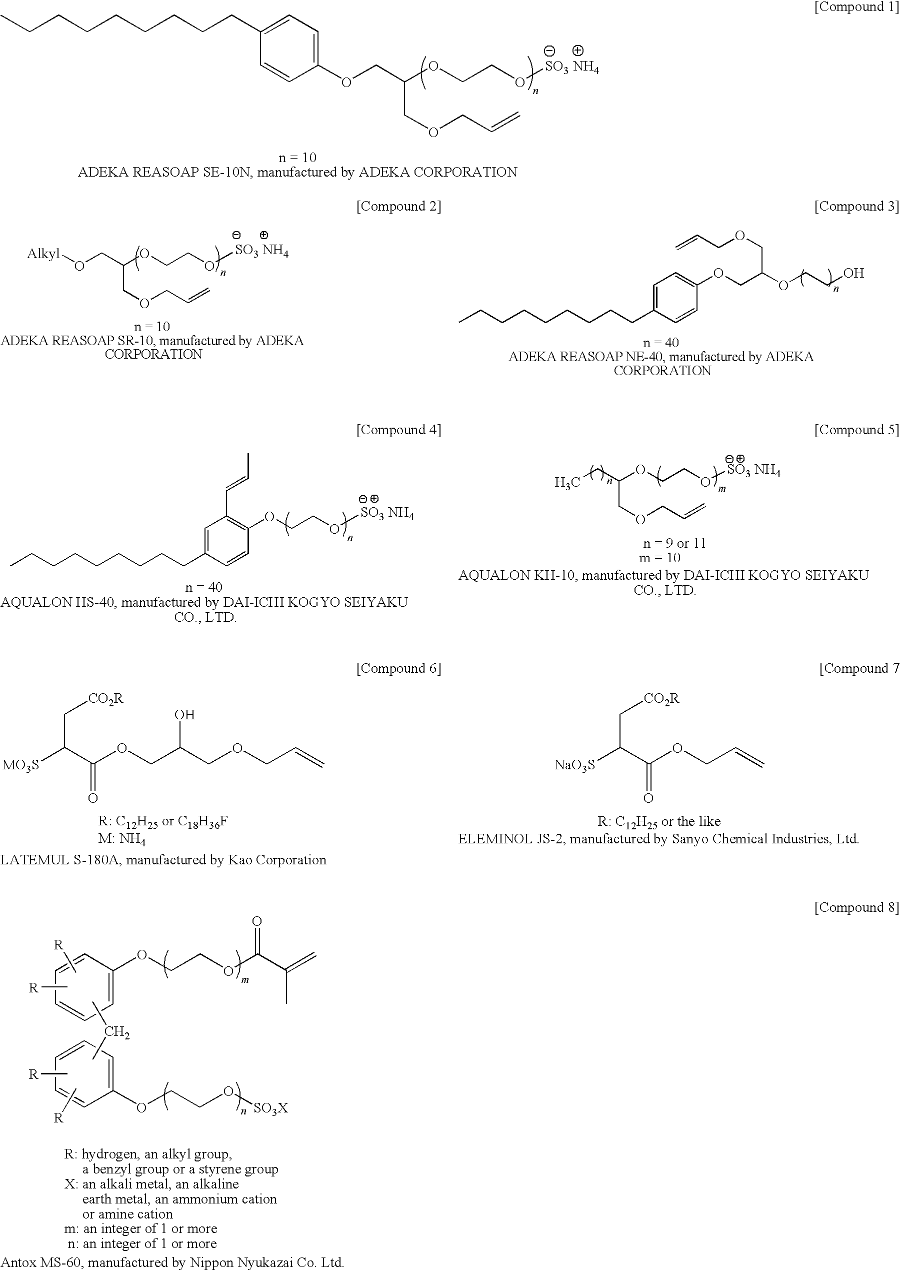

The organic fine particle dispersion by the build-up method for use in the present invention can be produced in a flow-type reactor having a particular equivalent diameter, and the equivalent diameter of the channel is preferably 10 mm or less, more preferably 1 mm or less, and particularly preferably 0.02 mm to 0.5 mm. The equivalent diameter is a term also called a corresponding diameter, which is used in mechanical engineering field. The equivalent diameter (d_{eq}) is defined as d_{eq}=4A/p in which A is a sectional area of the pipe, and p is a wetted perimeter length (circumferential length) of the pipe. In the case of the cylindrical pipe, this equivalent diameter corresponds to the diameter of the cylindrical pipe. The equivalent diameter is used for presuming fluidity or heat conducting characteristic of the pipe on the basis of data of the equivalent cylindrical pipe, and expresses a spatial scale (a representative length) of a phenomenon. The equivalent diameter is: d_{eq}=4a²/4a=a in a squared pipe having a side (a); d_{eq}=a/Error! Objects cannot be created from editing field codes. in an equilateral triangular pipe having a side (a); and d_{eq}=2h in a flow between paralleled plates having a channel height (h) (see, for example, edited by Nippon Kikai Gakkai, “Kikai Kougaku Jiten”, 1997, published by Maruzen, K. K.).

The flow of the liquid in the channel is preferably laminar flow in the step of producing an organic fine particle dispersion by the build-up method, although it is not limited thereto.

When causing water to flow into a pipe, insetting a narrow pipe into the pipe along the central axis thereof and then injecting a colored solution into the water, the colored solution flows in the form of a single line while the flow velocity of the water is small or slow. Thus, the water flows straightly and in parallel to the wall of the pipe. However, when the flow velocity is raised to reach a given flow velocity, turbulence is suddenly caused in the water flow. Consequently, the colored solution is mixed with the water flow so that the whole of the solution and water becomes a colored flow. The former flow is called laminar flow, and the latter flow is called turbulent flow.

Whether a flow turns to a laminiar flow or turbulent flow depends on whether or not the Reynolds number, which is a dimensionless number showing the state of the flow, is not more than a given critical value. As the Reynolds number is smaller, a laminar flow is more apt to be caused. The Reynolds number Re of the flow in a pipe is represented by the following equation:

Re=D<νₓ>ρ/μ

wherein D represents the equivalent diameter of the pipe, <νₓ> represents the sectional average velocity, ρ represents the density of the flow, and μ represents the viscosity of the flow. As can be understood from this equation, the Reynolds number is smaller as the equivalent diameter is smaller. Therefore, in the case that the equivalent diameter is in the order of μm, a stable laminar flow is apt to be formed. In addition, the physical properties of the solution, such as the density and the viscosity thereof, also have influence on the Reynolds number. As the density is smaller and/or the viscosity is larger, the Reynolds number is smaller. It can be, therefore, understood that a laminar flow is apt to be formed in that case.

The Reynolds number representing such a critical value is called “critical Reynolds number”. The critical Reynolds number is not necessarily definite. However, roughly, the following values can be criteria:

Re<2,300 laminar flow;

Re>3,000 turbulent flow; and

3,000≧Re≧2,300 transition state.

Hereinafter, a more preferred embodiment of the production method of the present invention will be explained.

As the equivalent diameter of a channel is smaller, the surface area per unit volume (specific surface area) thereof is larger. When the channel turns into a micro-scale, the specific surface area becomes remarkably large so that the conduction efficiency of heat through the wall of the channel becomes very high. Since the heat conduction time (t) of a fluid flowing in the channel is represented by: t=d_{eq}²/α (in which α is the heat diffusion rate of the fluid), the heat conduction time becomes shorter as the equivalent diameter becomes smaller. That is, if the equivalent diameter becomes 1/10, the heat conduction time becomes 1/100. Thus, when the equivalent diameter is in a micro-scale, the heat conduction speed is very high.

Precisely, in a micro-size space where the equivalent diameter is in micro-scale, flow has a small Reynolds number, and thus, a flow reaction can be conducted with the stable laminar flow being preferential. In addition, the interface between laminar flows has a very large interface surface area. This enables high-speed and precise mixing of component molecules owing to molecular diffusion between laminar flows, with keeping laminar flows. Further, use can be made of a channel wall having a large surface area, which enables precise temperature control; and controlling the flow rate in flow reaction enables precise control of reaction time. Therefore, among the channels where the laminar flow can be formed according to the present invention, a channel of micro scale that has an equivalent diameter with which the reaction can be highly controlled is defined as a micro reaction site.

As shown in the above explanation of Reynolds number, formation of laminar flow is largely influenced not only by the size of equivalent diameter of the channel but also by flowing conditions that include solution physical properties such as viscosity and density. Therefore, in the present invention, the equivalent diameter of the channel is not particularly limited as long as a laminar flow is formed in the channel, but the equivalent diameter is preferably of a size with which a laminar flow easily forms. The equivalent diameter of the channel is preferably 10 mm or less, and it is more preferably 1 mm or less since a micro reaction site can be formed. The equivalent diameter is further preferably 10 μm to 1 mm, and particularly preferably 20 to 500 μm.

A typical example of the reaction apparatus having such a micro-scale size flow path (channel) is commonly called “microreactor” and is being developed greatly in recent years (see, for example, W. Ehrfeld, V. Hessel, and H. Loewe, “Microreactor”, 1Ed. (2000) Wiley-VCH).

The above-mentioned general micro-reactor is provided with plural micro-channels each having an equivalent diameter (obtained by converting the section thereof to a corresponding circle) of several micrometers to several hundred micrometers; and a mixing space connected to these micro-channels. In the micro-reactor, plural solutions are introduced through the plural micro-channels into the mixing space, thereby mixing the solutions, or miixing the solutions and simultaneously causing chemical reaction.

Further, when a chemical substance that can be produced in only a small amount by use of an experimental producing-apparatus, is tried to produce in a large amount by use of large-scale manufacturing facilities (i.e. scaling up), huge labor and very long period of tine have been required hitherto, to gain the reproducibility of the manufacture in large-scale manufacturing facilities of a batch system as similar as the reproducibility of the production in the experimental producing-apparatus. However, by arranging a plurality of producing lines each using a micro-reactor in parallel (numbering-up) according to a necessary production quantity, labor and time period for gaining such the reproducibility may be largely reduced.

A method of producing the channels that can be used in the production of the organic fine particle dispersion according to the present invention will be described below. When the equivalent diameter of the channel is in the size of 1 mm or more, it is possible to produce the channel relatively easily by using a conventional machine processing technology. However, it becomles quite difficult to form them when the channel is in the microsize of 1 mm or less, especially of 500 μm or less. The micro-sized channel (microchannel) is often formed on a solid substrate by a micro manufacturing technology. The substrate material is arbitrary, if it is a stable material resistant to corrosion. Examples thereof include metals (such as stainless steel, hastelloy (nickel-iron alloy), nickel, aluminum, silver, gold, platinum, tantalum and titanium), glass, plastics, silicones, Teflon (registered trade name), ceramics, and the like.

Typical examples of the micro manufacturing technologies used in production of microchannels include LIGA (Roentgen-Lithographic Galvanik Abformung) technology by using X-Ray lithography, high-aspect-ratio photolithography by using EPON SU-8 (trade name), micro electro discharge machining (μ-EDM), high-aspect-ratio processing of silicon by Deep RIE (Reactive Ion Etching), hot embossing, optical modeling, laser processing, ion beam processing, mechanical micromachining by using a microtool of a hard material such as diamond, and the like. These technologies may be used alone or in combination. Preferable micro manufacturing technologies include LIGA technology using X-Ray lithography, high-aspect-ratio photolithography by using EPON SU-8, micro electro discharge machining (μ-EDM), and mechanical micromachining. Recently, application of fine injection molding technology to engineering plastics is also under study.

A junction technology is often used in preparation of microchannels. Generally junction technologies are divided grossly into solid-phase and liquid-phase bonding method, and the typical bonding methods generally used in solid-phase bonding include pressure welding and diffused junction, and those in liquid-phase bonding include welding, eutectic bonding, soldering, adhesion, and others. A high-precision junction method higher in dimensional accuracy without degradation of the material by high-temperature heating or breakdown of the microstructure such as channel by large deformation is desirable for assembly, and examples of such methods include silicon direct bonding, anodic bonding, surface-activated bonding, direct junction by hydrogen bonding, bonding by using aqueous hydrogen fluoride solution, eutectic gold-silicon junction, void-free adhesion, and the like.

The micro-channels that can be used in the producing method of the present invention are not limited to channels formed on a solid substrate by use of the micro processing technique, and may be, for example, various available fused silica capillary tubes each having an inner diameter of several micrometers to several hundred micrometers. Various silicon tubes, fluorine-containing resin tubes, stainless steel pipes, and PEEK (polyetheretherketone) pipes each having an inner diameter of several micrometers to several hundred micrometers, which are commercially available as parts for high-performance liquid chromatography or gas chromatography, can also be used.

The micro-channel that can be used in the present invention may be subjected to a surface treatment depending on applications. In particular, when handling an aqueous solution, since the adsorption of a sample to glass or silicon may become a problem, the surface treatment is important. In the fluid control in the micro-sized flow passage, it is desirable to realize this without incorporating a movable part requiring a complicated manufacturing process. For example, when a hydrophilic region and a hydrophobic region are prepared in the channel by the surface treatment, it becomes possible to treat a fluid by using a difference in surface tension exerting on the boundary between these regions. The method used for surface-treating glass or silicon in many cases may be hydrophobic or hydrophilic surface-treatment by using a silane coupling agent.

In order to introduce a reagent, sample, or the like into the channels and mix, a fluid control function may be needed. Specifically, since the behavior of the fluid in the micro channel has properties different from those in a macro-scale, a control method appropriate for the micro-scale should preferably be considered. A fluid control method is classified into a continuous flow system and a droplet (liquid plug) system according to the formation, while it is also classified into an electric driving system and a pressure driving system according to the driving force.

A more detailed description of these systems will be given hereinafter. The most widely used system as a formation for treating a fluid is the continuous flow system. When the flow is controlled in the continuous flow system, generally, the entire portion inside the micro-channel is filled with a fluid, and the fluid as a whole is driven by a pressure source such as a syringe pump that is provided outside the channel. In this method, although there is such a difficulty that dead volume is large, and the like, the continuous flow system has such a great merit that the control system can be realized with a relatively simple setup.

As a system which is different from the continuous flow system, there is provided the droplet (liquid plug) system. In this system, droplets partitioned by air are made to move inside the reactor or inside the channel leading to the reactor, and each of the droplets is driven by air pressure. During this process, a vent structure for allowing air between droplets and channel walls or air between the droplets to escape to the outside, if necessary; a valve structure for maintaining pressure inside the branched channels independently from pressure at other portions; and the like, must be provided inside the reactor system. Further, a pressure control system comprising a pressure source or a switching valve must be provided outside the reactor system in order to move the droplets by controlling the pressure difference. Thus, in the droplet system, although the apparatus configuration and the structure of the reactor become rather complicated as stated above, a multi-stage operation is enabled, for example, plural droplets are individually operated and some reactions are sequentially performed, and the degree of freedom concerning the system configuration becomes high.

In the present invention, the polymerization reaction should be carried out while the dispersion flows in the channel, independently of the flow systems.

The phrase “during the flow in a channel” means that two liquids flow in a channel having a certain length in the longitudinal direction, while the liquids occupy the entire cross section of the channel, and injection and collision of droplets or a liquid stream and also the liquid flow in the channel with residual partial cross-sectional opening are not included in the scope of the present invention.

As the driving system for performing the fluid control, there are generally and widely used an electrical driving method in which a high voltage is applied between both ends of a flow passage (channel) to generate an electro-osmiotic flow, thereby fluid is moved; and a pressure driving method in which a pressure is applied to a fluid from the outside of the passage using a pressure source to move the fluid. It has been known that both systems are different in that, for example, as the behavior of the fluid, the flow velocity profile in the cross-section of the flow passage becomes a flat distribution in the case of the electrical driving system, whereas it becomes a hyperbolic flow distribution in the pressure driving system, in which the flow velocity is high at the center of the flow passage and low at the wall surface part. Therefore, the electrical driving system is suitable for such an object that a movement is made while the shape of a sample plug or the like is kept. In the case where the electrical driving system is performed, since it is necessary that the inside of the flow passage is filled with the fluid, the form of the continuous flow system must be adopted. However, since the fluid can be treated by an electrical control, a comparatively complicated process is also realized, for example, a concentration gradient varying with time is formed by continuously changing the mixing ratio of two kinds of solutions. In the case of the pressure driving system, the control can be made irrespective of electrical properties of the fluid, and secondary effects such as heat generation or electrolysis may not be considered, and therefore, an influence on the substrate (component) hardly exists, and its application range is wide. On the contrary, a pressure source must be prepared outside, and for example, response characteristics to manipulation are changed according to the magnitude of a dead volume of a pressure system, and it is necessary to automate the complicated process.

Although a method to be used as a fluid control method can suitably be selected, the pressure driving system of the continuous flow system is preferable.

The temperature control in the channel may be performed by putting the whole device having a passage in a container in which the temperature is controlled; or forming a heater structure such as a metal resistance wire or polysilicon in the device, and performing a thermal cycle in such a manner that the heater structure is used when heating, and cooling is natural cooling. With respect to the sensing of temperature, when a metal resistance wire is used, it is preferable that the same resistance wire as the heater is additionally formed, and the temperature detection is performed on the basis of the change of the resistance value of the additional wire. When the polysilicon is used, it is preferable that a thermocouple is used to detect the temperature. Further, heating and cooling may be performed from the outside by bringing a Peltier element into contact with the channel. A suitable method can be selected in accordance with the use, the material of the channel body, and the like.

In the case of precipitating fine particles in the course of flowing through a channel, the reaction time can be controlled by a time during which they remain in the channel. When the equivalent diameter is constant, the retention time can be determined by the length of the channel and the induction speeds of the reaction solutions. Further, the length of the channel is not particularly limited, but it is preferably 1 mm or more but 10 m or less, more preferably 5 mm or more but 10 m or less, particularly preferably 10 mm or more but 5 m or less.

In the method of producing a polymer-processed organic fine particle dispersion of the present invention, the number of channels may be any number appropriately provided with a reactor. The number of channels may be one. Alternately, many channels may be used in parallel (i.e. numbering-up) as needed, to increase a processing amount thereof.

Microreactors specialized for mixing are called micromixers. There have been developed many devices different in the concept of mixing mode. Such devices are described in detail, for example, in W. Ehrfeld, V. Hessel, H. Loewe, “Microreactors”, 1st Ed. (2000), WILEY-VCH., Chapter 3 (p.41 to p.85). In the present invention, it is possible to produce an organic fine particle dispersion by using the device and mixing mode. Most of them use the diffusion phenomenon of the substance between the fluids to be mixed, and it is needed to increase the contact area of the fluids to be mixed for rapid and uniform mixing. In addition, JP-A-2005-288254 discloses a micromixer developed based on novel mixing concept that is improved in the efficiency of rapid and uniform mixing, compared to conventional models, applicable to various operational modes for mixing and resistant to clogging and allows stabilized continuous operation. The properties of the micromixer based on the concept are reported (H. Nagasawa, N. Aoki and K. Mae, “Design of a New Micromixer for Instant Mixing Based on the Collision of Micro Segments”, Chem. Eng. Technol., 28, No. 3, pp.324, 2005). The document showed that very rapid fluid mixing was possible in the new-model device based on the concept. The device for use in the present invention is not particularly limited, but the new-model reactor described above is used favorably.

Preferably in the present invention, in mixing the solution of an organic compound dissolved in solvent and the precipitation solvent as they are brought into contact with each other, at least one liquid stream is divided into multiple substreams and at least one substream in the divided multiple substream and the other liquid stream are mixed at a point in the junction region, as they are supplied with their axes directed crosswise. The divided multiple substreams are preferably brought into contact with each other and mixed, as they are supplied into the junction region through the channels extending radially from the junction region at the center.

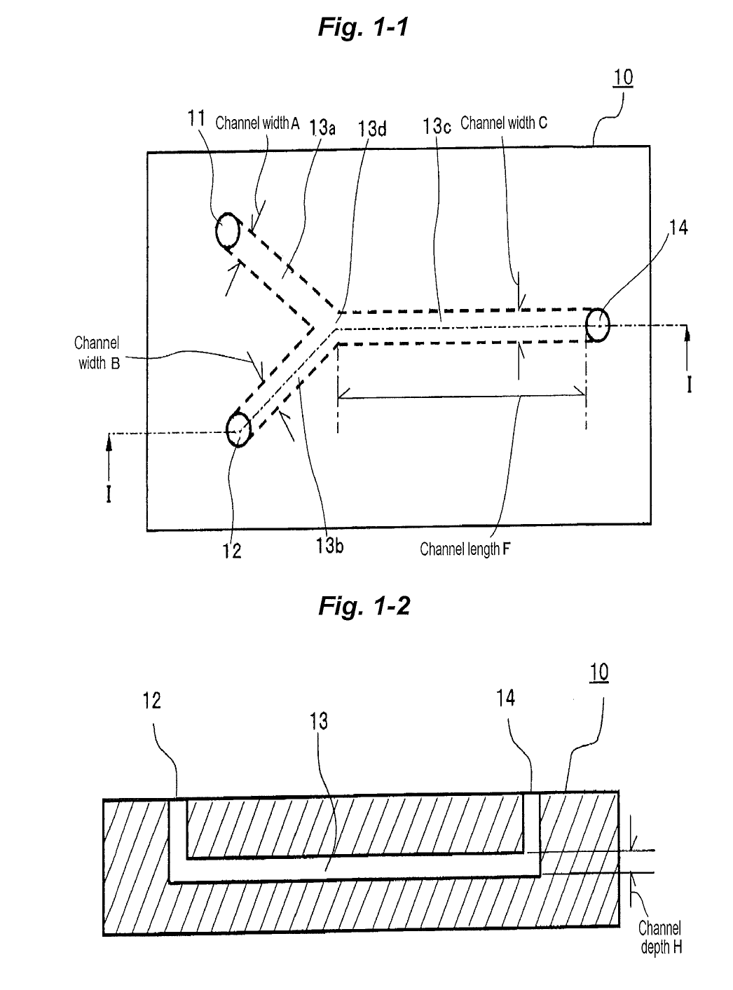

Preferred examples of a reactor that can be used in the method of producing an organic fine particle dispersion of the present invention are illustrated in FIGS. 1-1 to 8. Needless to say, the present invention is not limited to these examples.

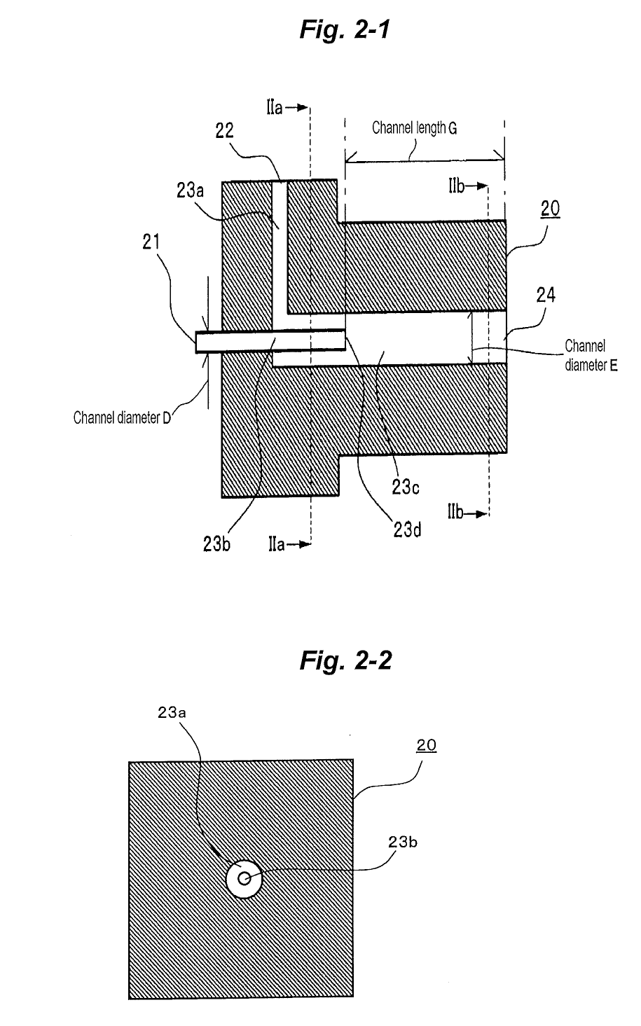

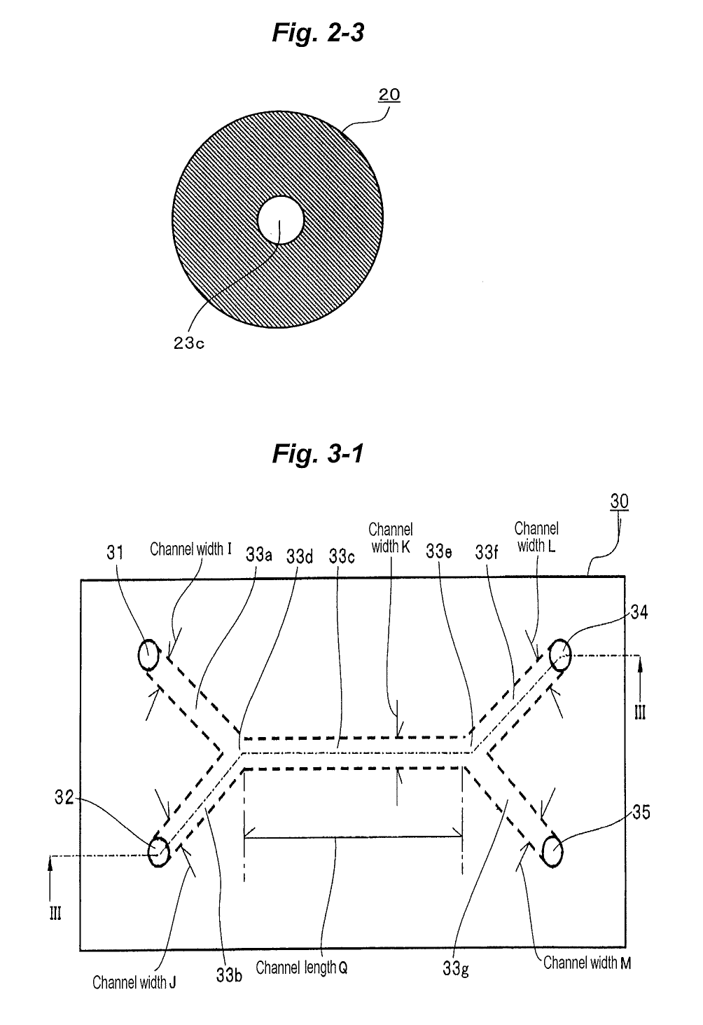

FIG. 1-1 is an explanatory view of one embodiment of a reactor 10 having a Y-shaped channel. FIG. 1-2 is a sectional view taken on I-I line of FIG. 1-1. The shape of the section perpendicular to the direction of the length of the channel is varied dependently on the micro processing technique to be used, and is preferably a shape close to a trapezoid or a rectangle. Further, it is preferable that width C and depth H are made into micrometer-sizes. Solutions introduced from introducing ports 11 and 12 with pumps or the like are caused to flow via introducing channels 13a or 13b, respectively, and are brought into contact with each other at a fluid confluence points 13d to preferably form stable laminar flows to flow through a reaction channel 13c. While the solutions flow as the laminar flows, a solute contained in a laminar flow is mixed or reacted with another solute contained in another laminar flow each other by molecular diffusion on the interface between the laminar flows. Solutes, which diffuse very slowly, may not be diffused or mixed between the laminar flows; and, in some cases, the solutes are not mixed until they reach a discharge port 14. In such a case that the two solutions to be introduced are easily mixed in a flask, the flow of the mixed solutions may become homogeneous flow in the discharge port if a channel length F is made long. However, when the channel length F is short, laminiar flows are kept up to the discharge port. When the two solutions to be introduced are not mixed in a flask and are separated into phases, the two solutions naturally flow as laminar flows to reach the discharge port 14.

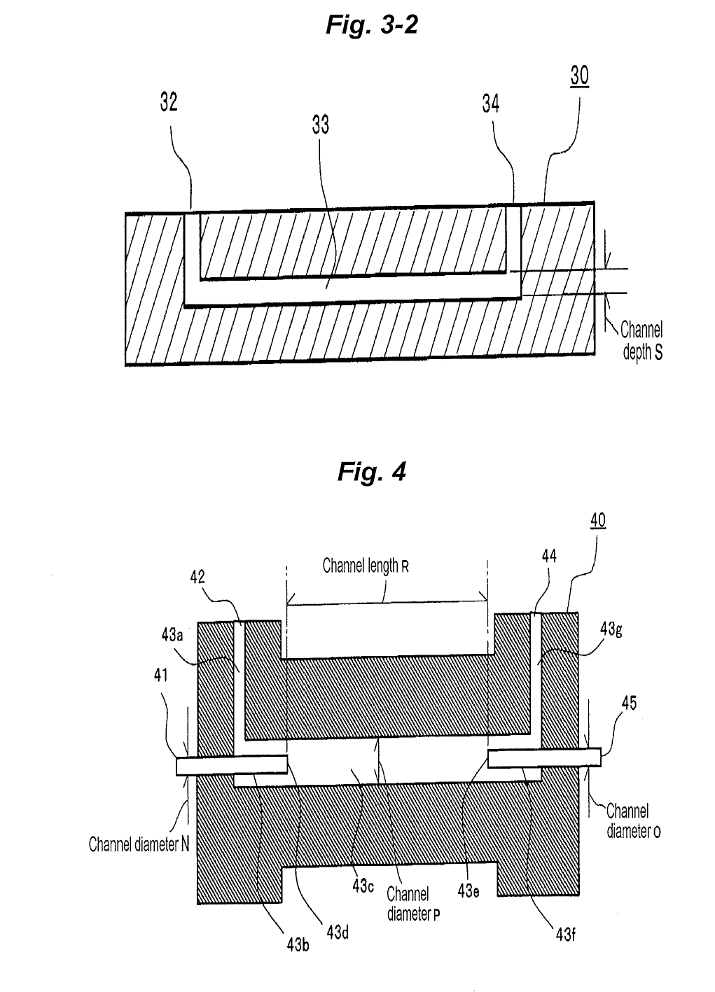

FIG. 2-1 is an explanatory view of a reactor 20 having a cylindrical pipe-type channel in which a channel is inserted at one side thereof. FIG. 2-2 is a sectional view of the reactor taken on line IIa-IIa of FIG. 2-1, and FIG. 2-3 is a sectional view of the reactor taken on line IIb-IIb of FIG. 2-1. The shape of the section perpendicular to the direction of the length of the channel is preferably a circular shape or a shape close thereto. In this case, it is preferable that the channel diameters (D and E) of the cylindrical pipes are micrometer-sizes. Solutions introduced from introducing ports 21 and 22 with pumps or the like are caused to flow via introducing channels 23b or 23a, respectively, and are brought into contact with each other at a fluid confluence point 23d to preferably form stable cylindrical laminar flows to flow through a reaction channel 23c. While the solutions flow as the cylindrical laminar flows, solutes contained in the separate laminar flows are mixed or reacted with each other by molecular diffusion on the interface between the laminiar flows. This matter is the same as in the case of the reactor, as illustrated in FIG. 1-1. The apparatus having the cylindrical pipe-type channel has the following characteristics: that the apparatus can make the contact interface between the two solutions larger than the apparatus illustrated in FIG. 1-1; and since the contact interface has no portion to contact the wall face of the apparatus, it does not happen that crystal growth is caused from the contact portion with the wall face as in the case that a solid (crystal) is generated by reaction, thereby the apparatus gives only a low possibility that the channel is clogged.

FIGS. 3-1 and 4 illustrate apparatuses obtained by improving the apparatuses illustrated in FIGS. 1-1 and 2-1, respectively, in order that when flows of two solutions arrive at outlets in the state that the flows are laminar flows, the laminiar flows can be separated. When these apparatuses are used, reaction and separation can be attained at the same time. It is also possible to avoid phenomena that the two solutions are finally mixed so that the reaction between the solutions advances excessively, and that generated crystals get coarse. In the case that products or crystals are selectively present in one of the solutions, the products or crystals can be obtained with a higher concentration than in the case that the two solutions are mixed. Further, by linking a plurality of the apparatuses to each other, there are such advantages that an extracting operation is effectively performed.

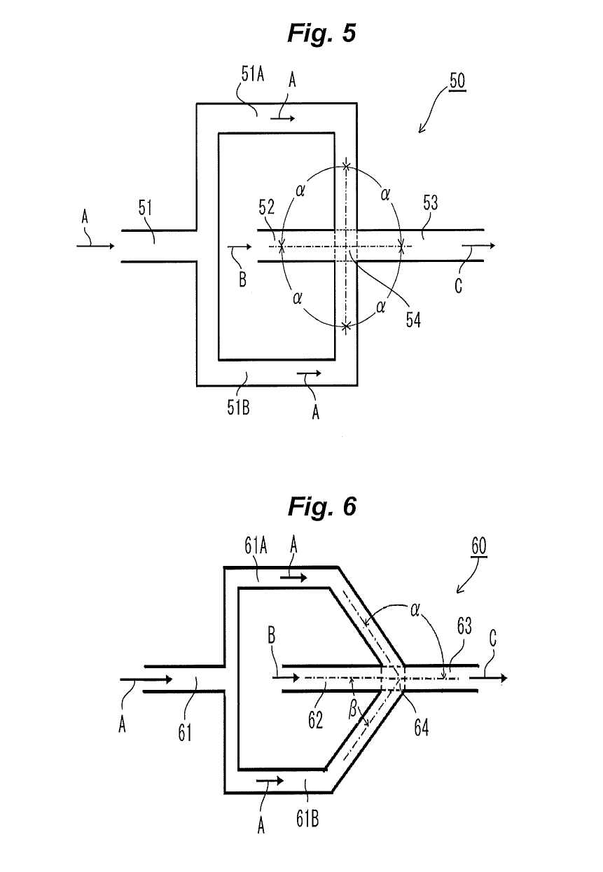

A micro-reactor 50 shown in FIG. 5 is configured in such a manner that two divided supply flow paths 51A, 51B that are divided from one supply flow path 51 for supplying a solution A so as to divide the solution A into two, one supply flow path 52 for supplying a solution B, which is not divided, and a micro-flow path 53 for effecting a reaction between the solutions A and B are communicated with each other in one junction region 54. In FIGS. 5 to 8, an arrow shows the flow direction of a solution A, B, or C. Further, the divided supply flow paths 51A, 51B, the supply flow path 52, and the micro-flow path 53 are placed with an equal interval at 90° around the junction region 54 substantially in an identical plane. More specifically, center axes (alternate long and short dash lines) of the respective flow paths 51A, 51B, 52, and 53 cross each other in a cross shape (cross angle α=90°) in the junction region 54. In FIG. 5, although only the supply flow path 51 of the solution A is divided so as to allow to make its supply amount to be larger than that of the solution B, the supply flow path 52 of the solution B may also be divided into a plurality of paths. Further, the cross angle α of the respective flow paths 51A, 51B, 52, and 53 placed around the junction region 54 is not limited to 90°, and can be set appropriately. Further, the number of division of the supply flow paths 51, 52 is not particularly limited. However, when the number of division is too large, the configuration of the micro-reactor 50 becomes complicated. Therefore, the number of division is preferably 2 to 10, and more preferably 2 to 5.

FIG. 6 is an explanatory view illustrating another embodiment of the plane-type microreactor. In a microreactor 60, a cross angle β formed by center axes of divided supply flow paths 61A, 61B with respect to a center axis of a supply flow path 62 is smaller than 90° of FIG. 5 and is 45°. Further, the microreactor 60 is configured so that a cross angle α formed by a center axis of a micro-flow path 63 with respect to the center axes of the divided supply flow paths 61A, 61B is 135°.

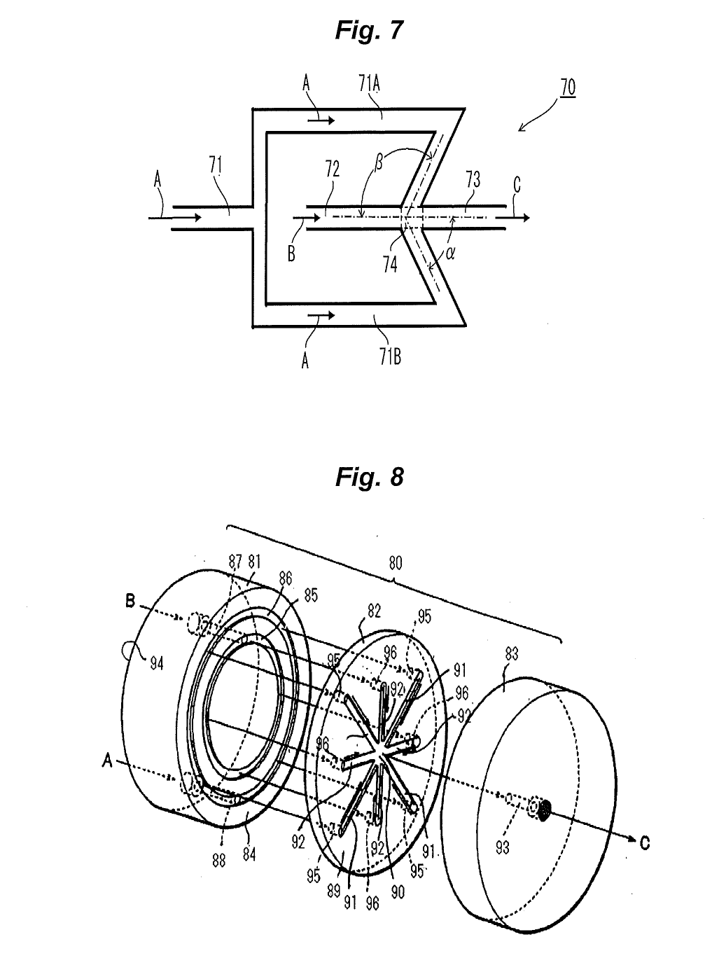

FIG. 7 is an explanatory view illustrating still another embodiment of the plane-type microreactor. In a microreactor 70, a cross angle β formed by center axes of divided supply flow paths 71A, 71B through which the solution A flows with respect to a center axis of the supply flow path 72 through which a solution B flows is larger than 90° of FIG. 5 and is 135°. Further, the microreactor 70 is configured so that a cross angle a formed by a center axis of a micro-flow path 73 with respect to the center axes of the divided supply flow paths 71A, 71B becomes 45°. The cross angles α, β of the supply flow path 72, the divided supply flow paths 71A, 71B, and the micro-flow path 73 can be set appropriately. However, assuming that the sum of cross-sections in a thickness direction of the joined solutions B and A is S1, and the cross-section in a diameter direction of the micro-flow path 73 is S2, it is preferable to set the cross angles α, β so as to satisfy S1>S2. This can further increase the contact area between the solutions A, B, and further decrease the diffusion/mixing distance thereof, so that the mixing becomes likely to occur more instantaneously.

FIG. 8 is an exploded perspective view showing an embodiment of a three-dimensional microreactor under the condition that three parts constituting the microreactor 80 are decomposed. The three-dimensional microreactor 80 is mainly composed of a supply block 81, a junction block 82, and a reaction block 83, each having a cylindrical shape. For assembling the microreactor 80, the side faces of the blocks 81, 82, 83 having a cylindrical shape are attached to each other in this order to form a cylinder, and in this state, the respective blocks 81, 82, 83 are fastened integrally with a bolt-nut, etc.

On a side face 84 of the supply block 81 opposed to the junction block 82, two annular grooves 86, 85 are formed concentrically, and in the assembled state of the microreactor 80, two annular grooves 86, 85 form ring-shaped flow paths through which the solutions B and A flow respectively. Then, through-holes 88, 87 are respectively formed so as to reach the outside annular groove 86 and the inside annular groove 85 from a side face 94 of the supply block 81 not opposed to the junction block 82. Among two through-holes 88, 87, supply means (a pump, a connecting tube, etc.) for supplying the solution A is connected to the through-hole 88 communicated with the outside annular groove 86, and supply means (a pump, a connecting tube, etc.) for supplying the solution B is connected to the through-hole 87 communicated with the inside annular groove 85. In FIG. 8, although the solution A is allowed to flow through the outside annular groove 86, and the solution B is allowed to flow through the inside annular groove 85, they may be opposite.

At a center of a side face 89 of the junction block 82 opposed to the reaction block 83, a circular junction hole 90 is formed, and four long radial grooves 91 and four short radial grooves 92 are formed alternately in a radial manner from the junction hole 90. In the assembled state of the microreactor 80, the junction hole 90 and the radial grooves 91, 92 form a circular space to be a junction region 90 and radial flow paths through which the solutions A, B flow. Further, through-holes 95, are respectively formed in a thickness direction of the junction block 82 from the tip ends of the long radial grooves 91 among eight radial grooves 91, 92, and these through-holes 95 are communicated with the above-mentioned outside annular groove 86 formed in the supply block 81. Similarly, through-holes 96, are respective formed in a thickness direction of the junction block 82 from the tip ends of the short radial grooves 92, and the through-holes 96 are communicated with the inside annular groove 85 formed in the supply block 81.

In addition, a through-hole 93 extending in the junction region 90 in the thickness direction of the reaction block 83 is formed in the center of the reaction block 83, and the through-hole 93 serves as the microchannel.

Thus, the liquid A flows through the through-hole 88 of a supply block 81, via an outside annular groove 86 and through the through-hole 95 of a junction block 82, into the supply channel of long radial grooves 91. The four divided streams reach the junction region 90. On the other hand, the liquid B flows through the through-hole 87 of supply block 81, the inside annular groove 85 and the junction block 82 of through-hole 96 into the supply channel of short radial grooves 92. The four divided streams reach the junction region 90. In the junction region 90, the divided streams of liquid A and the divided streams of liquid B are brought into contact with each other respective with their kinetic energy, and flow into the microchannel 93, while the flow direction is changed by 90°.

Any one of the devices shown in FIGS. 1 to 8 may be used preferably in the present invention; the devices shown in FIGS. 5 to 8 are used preferably; and the device shown in FIG. 8 is used more preferably. In this way, particularly in the production method of the present invention, the efficiency of rapid mixing of the organic pigment dispersion and the precipitation medium during precipitation of fine particles in the presence of the polymerizable compound is improved, and the dispersion stability and the storage stability of the organic fine particle dispersion during polymerization and immobilization of the polymerizable compound are improved further. The device, which suppresses or prevents channel clogging and is superior in production stability and numbering-up compatibility, is used particularly preferably for production of the organic fine particle dispersion according to the present invention.

When production of organic fine particles by the build-up method is carried out in a microreactor, the rate of the flowing fluid (flow rate) in the channel is preferably 0.1 mL/hour to 300 L/hour, more preferably 0.2 mL/hour to 30 L/hour, and still more preferably 0.5 mL/hour to 15 L/hour, and particularly preferably 1.0 mL/hour to 6 L/hour.

In the present invention, the polymerization processing is performed continuously, with a dispersion liquid containing organic fine particles (preferably fine particles in the nanometer order of approximately 10 nm or more 100 nm or less) and additionally a polymerizable compound that is previously or freshly prepared. If the organic fine particle dispersion liquid is processed, for example for purification or concentration, after preparation, the polymer processing according to the present invention may be performed at any stage and the order of processings is arbitrary. For example, the organic fine particle dispersion may be washed and concentration after polymer processing in the channel; the dispersion after the washing step may be re-circulated into the channel for polymer processing and the resulting dispersion concentrated; or the dispersion after the washing and concentration steps may be re-circulated into the channel for polymer processing. The dispersion after polymerization processing is preferably washed and concentrated in the channel, for convenience in handling.

As one of the methods of performing the polymer processing in the channel according to the present invention, particle precipitation and polymer processing can be performed continuously, as the outlet of the microreactor responsible for the step of producing an organic fine particle dispersion by coprecipitation method is connected to the inlet of the channel for polymer processing. Such a continuous method is not only preferable from the point of production cost, but also has an advantage that it is possible to produce a fine particle dispersion uniform in particle diameter and particle diameter distribution reliably by performing polymer processing, which is effective in improving dispersion stability, immediately after particle generation.

When the organic fine particles produced by the coprecipitation method are polymer-processed, the polymerizable compound used in the polymer processing may be dissolved in the organic compound solution or the precipitation solvent before or after preparation of the fine particles by contact of the organic compound solution with the precipitation solvent. It may be added simultaneously with mixing of the organic compound solution with the precipitation solvent (i.e., simultaneous addition of 3 or more liquids). If the polymer processing is performed by a radical polymerization by using a polymerization initiator, the polymerization initiator may be dissolved in the organic compound solution or the precipitation solvent before or after preparation of the fine particles. It may be added simultaneously with mixing of the two liquids (i.e., simultaneous addition of 3 or more liquids). The polymerizable compound and the polymerization initiator are preferably added to different solutions, and more preferably, the polymerizable compound is added to the organic compound solution and the polymerization initiator to the precipitation solvent.

Drying of the polymer-processed organic fine particle dispersion obtained in the present invention gives a polymer-processed organic fine particle solid. The drying method may be a common method and is not particularly limited, and examples thereof include freeze drying, distillation under reduced pressure (evaporation), the combination thereof and the like. The content of the organic pigment after the dispersion is converted into the solid or concentrated state is not particularly limited, but preferably 5 mass % to 90 mass %, more preferably 20 mass % to 80 mass %.

When the polymer-processed organic fine particles according to the present invention are organic pigment fine particles or the dispersion thereof, the particles can give an ink-jet ink superior in properties. For example, an ink is prepared by adding a water-soluble high-boiling organic solvent such as glycerols or glycols to a polymer-processed organic pigment fine particle dispersion previously purified by centrifugation and/or ultrafiltration and concentrated as needed. A desired ink-jet recording ink can be prepared by adding, as needed, additives such as pH-, surface tension-, and viscosity-adjusting agents and antiseptics.

Subsequent separation, concentration and/or adjustment of liquid physical properties described above, as needed, gives a dispersion for high-performance color filters. A paint can be prepared by processing in the concentration, resin addition, liquid physical properties adjustment and other steps.

The present invention can provide a method of producing a polymer-processed organic fine particle dispersion that allows control for adjustment of the molecular weight and narrowing of the molecular weight distribution of the polymer as a fastened dispersant and prohibits fluctuation in the molecular weight distribution during the continuous production of the dispersion in preparing a dispersion of dispersion particles stabilized with a polymer fastening (or adsorbing) organic fine particles. In other words, it is possible by the method of the present invention, to produce a monodispersion dispersion narrower in particle size distribution and lower in fluctuation in average diameter of the polymer-fastening dispersion particles between immediately after preparation and after long-term storage.

In addition, the present invention can provide a method allowing scale up of the production of the dispersion-stabilized high-quality organic fine particle dispersion by using the above-mentioned method.

Further, the method of the present invention, in which polymerization is performed during flow in a channel and thus, the control of the reaction temperature and others is simple, allows mass production of a high-quality stabilized organic fine particle dispersion fastening a polymer as a dispersant.

The organic pigment fine particle dispersion obtained by the method of the present invention is favorable, for example, for use in ink-jet recording ink and paint.

### EXAMPLES

The present invention will be described in more detail based on the following examples, but the present invention is not limited thereto.

### Example 1

80 g of Pigment Yellow 128 (CROMOPHTAL YELLOW 8GNP, trade name, manufactured by Ciba Specialty Chemicals), 63 g of 28% sodium methoxide methanol solution (manufactured by Wako Pure Chemical Industries Co., Ltd.), 56 g of Aqualon KH-10 (trade name, manufactured by Dai-ichi Kogyo Seiyaku Co., Ltd.), and 8.0 g of N-vinylpyrrolidone (manufactured by Wako Pure Chemical Industries Co., Ltd.) were dissolved in 1,200 mL of dimethylsulfoxide at room temperature, to give a solution I. 3.6 g of 2,2′-azobis(2-amidiniopropane) dihydrochloride salt (trade name: V-50, manufactured by Wako Pure Chemical Industries Co., Ltd.) was dissolved in 5 L of distilled water, to give a solution II. The three-dimensional microreactor apparatus shown in FIG. 8 having the channels (division number) and others described below was used as the microreactor apparatus.

Number (n) of Supply channel: Divided into 3 channels of two kinds of reaction solutions (6 channels in total are joined. In the apparatus shown in FIG. 8, 8 channels in total (4 each) are joined.)

Width (W) of supply channels 91 and 92: 400 μm each

Depth (H) of supply channels 91 and 92: 400 μm each

Diameter (D) of junction region 90: 800 μm

Diameter (R) of microchannel 93: 800 μm

Length (L) of microchannel 93: 10 mm

Intersection angle between each supply channel 91 or 92 and the microchannel 93 in the junction region 90: 90°

Material of apparatus: Stainless steel (SUS304)

Channel-machining method: Micro-discharge machining was performed, and three parts of the supply block 81 junction block 82 and reaction block 83 were sealed with the metal surface seal after mirror polishing. Two Teflon (registered trademark) tubes having a length of 50 cm and an equivalent diameter of 1 mm were connected respectively to two inlets and also to tanks containing solutions I and II at the other ends. A Teflon (registered trademark) tube having a length of 1.5 m and an equivalent diameter of 1 mm was connected to the connector outlet; a stainless steel tube having a length of 2 m and an equivalent diameter of 1.6 mm was connected thereto; and a Teflon (registered trademark) tube having a length of 10 m and an equivalent diameter of 8 mm was connected thereto additionally. A temperature sensor for measurement of liquid temperature was connected to the connection region between the stainless steel tube and the Teflon (registered trademark) tube having an equivalent diameter of 8 mm.

The solutions I and II were fed at flow rates respectively of 20 mL/min and 80 mL/min in the microreactor apparatus, while the stainless steel tube and about 6 m length of the Teflon (registered trademark) tube having an equivalent diameter of 8 mm connected thereto was immersed in an oil bath kept at a temperature of 80° C. The liquid temperature, as determined by the sensor installed at the end of the stainless steel tube, was almost constant at 78 to 80° C., indicating that the heat exchange was complete in the stainless steel tube. A Pigment Yellow 128 dispersion liquid discharged from the outlet of the Teflon (registered trademark) tube was collected. The heating time of the liquid was calculated to be approximately 180 seconds.

The liquid was purified in an ultrafiltration apparatus (UHP-62K, trade name, manufactured by Advantec Mfg, Inc., molecular cutoff: 50,000), while distilled water was added and the filtrate removed, keeping the volume of the liquid therein constant and then concentrated to a pigment concentration of 5.0 mass %. The viscosity of the 5.0 mass % pigment dispersion was 3.2 mPa·s; the volume-average particle diameter Mv of the pigment particles in the liquid was 24.1 nm; the ratio of volume-average particle diameter Mv/number-average particle diameter Mn, which is an indicator of monodispersibility, was 1.34. The particle diameter (Mv) and the monodispersibility (Mv/Mn) of the pigment particles were determined by Nanotrac UPA-EX150 (trade name) manufactured by Nikkiso Co., Ltd. at room temperature (around 25° C.), after the dispersion was diluted with distilled water to a pigment concentration of 0.2 mass %. The same is true in the following Examples and Comparative Examples.

Subsequently, a continuous heating test was carried out at 60° C. for 100 hours and additionally for 240 hours, and the volume-average particle diameters Mv were respectively 24.2 nm and 24.2 nm, and the Mv/Mn ratios were respectively 1.35 and 1.35, showing almost no change, and there was no precipitation observed.

The test results are summarized in the following Table 1.

### Example 2

80 g of Pigment Yellow 128 (CROMOPHTAL YELLOW 8GNP, trade name, manufactured by Ciba Specialty Chemicals), 63 g of 28% sodium methoxide methanol solution (manufactured by Wako Pure Chemical Industries Co., Ltd.), 56 g of Aqualon KH-10 (trade name, manufactured by Dai-ichi Kogyo Seiyaku Co., Ltd.), 8.0 g of N-vinylpyrrolidone (manufactured by Wako Pure Chemical Industries Co., Ltd.), and 3.6 g of 2,2′-azo(isobutylonitrile) (AIBN, manufactured by Wako Pure Chemical Industries Co., Ltd.) were dissolved in 1,200 mL of dimethylsulfoxide at room temperature, to give a solution I. Distilled water was used as solution II. These solutions were processed in an apparatus similar to Example 1 by a method similar to Example 1, to give a 5.0 mass % pigment dispersion liquid. Results of particle diameter measurement and continuous heat test of the dispersion are shown in Table 1. As is apparent from Table 1, there was no precipitation observed during the continuous heat test.

The test results are summarized in the following Table 1.

### Example 3

A 5.0 mass % pigment dispersion was prepared in the same manner as in Example 1, except that 2,2′-azobis(2-amidinopropane)dihydrochloride salt (trade name: V-50, manufactured by Wako Pure Chemical Industries Co., Ltd.) used in Example 1 was replaced with 39 g of VPE0201. Results of particle diameter measurement and continuous heat test of the dispersion liquid are shown in the following Table 1. As is apparent from the Table, there was no precipitation observed during the continuous heat test.

### Example 4

A 5.0 mass % pigment dispersion liquid was prepared in the same manner as in Example 1, except that N-vinylpyrrolidone used in Example 1 was replaced with 4.0 g of styrene (purified by distillation; manufactured by Wako Pure Chemical Industries Co., Ltd.) and 4.0 g of acrylic acid (purified by distillation; manufactured by Wako Pure Chemical Industries Co., Ltd.). Results of particle diameter measurement and continuous heat test of the dispersion liquid are shown in the following Table 1. As is apparent from the Table, there was no precipitation observed during the continuous heat test.

### Example 5

A 5.0 mass % pigment dispersion liquid was prepared in the same manner as in Example 1, except that the temperature of the oil bath used in Example 1 was changed from 80° C. to 55° C. (the liquid temperature, as determined by the sensor installed at the end of the stainless steel tube, was almost constant at 54 to 55° C.). Results of particle diameter measurement and continuous heat test of the dispersion liquid are shown in the following Table 1.

### Comparative Example 1

The experiment of Example 1 was repeated while the dispersion was not heated in the oil bath, and a Pigment Yellow 128 dispersion liquid discharged from the tip of 10 the outlet of the Teflon (registered trademark) tube was collected. The liquid was processed in the same manner as in Example 1, to give a 5.0 mass % pigment dispersion.

Results of particle diameter measurement and continuous heat test of the dispersion liquid are shown in the following Table 1. The dispersion liquid obtained by the method without the polymerization step was found to show large change in particle diameter in the continuous heat test.

### Example 6

The Pigment Yellow 128 dispersion liquid discharged from the tip of the outlet of the Teflon (registered trademark) tube in the Comparative Example 1 was fed into a tank; a Teflon (registered trademark) tube having a length of 1.5 m and an equivalent diameter of 1 mm was connected to the outlet of the tank; a stainless steel tube having a length of 2 m and an equivalent diameter of 1.6 mm was connected thereto; and a Teflon (registered trademark) tube having a length of 10 m and an equivalent diameter of 8 mm was connected thereto additionally. A temperature sensor for liquid temperature was connected to the connecting region between the stainless steel tube and the Teflon (registered trademark) tube having an equivalent diameter of 8 mm. The dispersion liquid was fed fom the tank at a flow rate of 100 mL/min, while the stainless steel tube and a 6-m length of the Teflon (registered trademark) tube having an equivalent diameter of 8 mm connected thereto were immersed in an oil bath kept at a temperature of 80° C. The liquid temperature, as determined by the sensor installed at the tip of the stainless steel tube, was almost constant at 78 to 80° C. The dispersion obtained was processed similarly to Example 1, to give a 5.0 mass % pigment dispersion liquid. Results of particle diameter measurement and continuous heat test of the dispersion liquid are shown in the following Table 1.

### Comparative Example 2

The Pigment Yellow 128 collected from the tip of the outlet of the Teflon (registered trademark) tube in the Comparative Example 1 was transferred into a flask, heated under nitrogen atmosphere at 80° C. for 30 minutes, and processed in the same manner as in Example 1, to give a 5.0 mass % pigment dispersion liquid. Results of particle diameter measurement and continuous heat test of the dispersion liquid are shown in the following Table 1. The results in Comparative Example 2 showed that if polymerization was carried out not during the flow in a channel, but in a flask under inert gas atmosphere, the dispersion was not favorable in stability of the average diameter over time although there was no precipitation generated.

### Comparative Example 3

The Pigment Yellow 128 dispersion liquid collected from the tip of the outlet of the Teflon (registered trademark) tube in the Comparative Example 1 was transferred into a flask, heated under atmosphere at 80° C. for 30 minutes, and processed in the same manner as in Example 1, to give a 5.0 mass % pigment dispersion liquid. Results of particle diameter measurement and continuous heat test of the dispersion liquid are shown in the following Table 1. The results in Comparative Example 3 showed that if polymerization was carried out not during the flow in a channel, but under atmosphere, the dispersion was not favorable in stability of the average diameter over time as well as there was precipitation generated.

### Example 7

The composition of the solution I used in Example 1 was 80 g of 2,9-dimethyl quinacridone (HOSTAPERM PINK E, trade name, manufactured by Clariant), 181 g of 28% sodium methoxide methanol solution (manufactured by Wako Pure Chemical Industries Co., Ltd.), 56 g of Aqualon KH-10 (trade name, manufactured by Dai-ichi Kogyo Seiyaku Co., Ltd.), 8.0 g of N-vinylpyrrolidone (manufactured by Wako Pure Chemical Industries Co., Ltd.), and 1,200 ml of dimethylsulfoxide. A solution of 3.6 g of 2,2′-azobis(2-amidinopropane)dihydrochloride salt (trade name V-50, manufactured by Wako Pure Chemical Industries Co., Ltd.) dissolved in 5 L of distilled water was used as the solution II. A 5.0 mass % pigment dispersion was prepared in the same manner as in Example 1 by using these solutions. Results of particle diameter measurement and the continuous heat test of the dispersion liquid are shown in the following Table 1.

### Comparative Example 4

The experiment of Example 7 was repeated while the dispersion liquid was not heated in the oil bath, and a 2,9-dimethyl quinacridone dispersion liquid discharged from the tip of the outlet of the Teflon (registered trademark) tube was collected. The dispersion liquid was transferred into a flask, heated under nitrogen atmosphere at 80° C. for 30 minutes, and processed in the same manner as in Example 1, to give a 5.0 mass % pigment dispersion liquid. Results of particle diameter measurement and continuous heat test of the dispersion are shown in the following Table 1. The results in Comparative Example 4 showed that if polymerization was carried out not during the flow in a channel, but in a flask under inert gas atmosphere, the dispersion was not favorable in stability of the average diameter over time although there was no precipitation generated.

As is apparent from the results, the polymer-processed organic pigment dispersions according to the present invention obtained in Examples 1 to 7 are superior in monodispersibility and long-term dispersion stability, compared to Comparative Examples. The change of the dispersion particles over time was also small and there was no precipitation observed.

TABLE 1

| | Average particle | | | | | | |
|---|---|---|---|---|---|---|---|
| | diameter (Mv) | | | Mv/Mn | | | |
| | | 60° C. | 60° C. | | 60° C. | 60° C. | Generation of |
| | Initial value | 100 hr | 240 hr | Initial value | 100 hr | 240 hr | precipitation |
| Example 1 | 24.1 | 24.2 | 24.2 | 1.34 | 1.35 | 1.35 | None |
| Example 2 | 24.4 | 24.6 | 24.7 | 1.36 | 1.41 | 1.55 | None |
| Example 3 | 24.8 | 25.1 | 26.3 | 1.35 | 1.39 | 1.48 | None |
| Example 4 | 22.3 | 25.5 | 26.9 | 1.34 | 1.42 | 1.48 | None |
| Example 5 | 23.9 | 25.2 | 27.4 | 1.34 | 1.44 | 1.51 | None |
| Example 6 | 24.4 | 25.3 | 25.6 | 1.38 | 1.42 | 1.44 | None |
| Comparative | 23.8 | 25.8 | 29.4 | 1.34 | 1.46 | 1.55 | Observed |
| Example 1 | | | | | | | |
| Comparative | 24.4 | 26.4 | 28.8 | 1.40 | 1.53 | 1.58 | None |
| Example 2 | | | | | | | |
| Comparative | 23.7 | 25.6 | 29.1 | 1.44 | 1.46 | 1.51 | Observed |
| Example 3 | | | | | | | |
| Example 7 | 22.1 | 22.1 | 22.2 | 1.31 | 1.33 | 1.33 | None |
| Comparative | 25.8 | 27.0 | 33.2 | 1.42 | 1.46 | 1.60 | None |
| Example 4 | | | | | | | |

### Example 8

An inkjet ink was prepared in the following composition by using each of the 5% concentration dispersions of Examples 1 to 7 after polymerization processing, purification by ultrafiltration, and concentration:

Organic pigment (3.5%)

Olefin E1010 (2.0%)

Glycerol (10%)

Water (84.5%)

The ink-jet ink was evaluated in an ink ejection test, as it is used as the ink of a printer PM-D600 (trade name) manufactured by Seiko Epson Corp., giving favorable prints without clogging.

### Example 9

A paint was prepared by using each of the 5% concentration dispersions of Examples 1 to 7 after polymerization processing, purification by ultrafiltration and concentration, and by mixing it with a resin in the following composition.

Organic pigment (5%): Julimer ET-410 (trade name, manufactured by Nihon Junyaku Co., Ltd., 30%)=2:1

The paint was spotted dropwise on a glass plate with a dropping pipette and dried under heat at 40° C. for 2 hours, to give a transparent brilliant coated film.

### Example 10

1.0 g of the exemplary compound (I-1) and 0.5 g of N-vinylpyrrolidone were dissolved in 50 mL of tetrahydrofuran (THF), together with 1.5 g of Aqualon KH-10 (trade name, manufactured by Dai-ichi Kogyo Seiyaku Co., Ltd.) at room temperature (solution IA). Aqueous (0.1%) K₂S₂O₈ solution was used as solution IIA. These solutions were filtered through a 0.45-μm microfilter (manufactured by SARTORIUS K.K.) for removal of impurities such as foreign particles. An organic fine particle dispersion was prepared in an apparatus by an operation similar to Example 1. The particle diameters determined before and after heat test and the results of monodispersibility measurement are summarized in the following Table 2.

### Example 11

An organic fine particle dispersion liquid was prepared in an apparatus and by an operation similar to Example 1, except that N-vinylpyrrolidone in Example 10 was replaced with styrene in the same amount and KH-10 with sodium lauryl sulfate in the same amount. The particle diameters determined before and after heat test and the results of monodispersibility measurement are summarized in the following Table 2.

### Examples 12 to 16

An organic fine particle dispersion liquid was prepared in the same manner as in Example 10, except that the rate of the polymerizable compound to the polymerizable surfactant in Example 10 was changed to that shown in the following Table 2.

TABLE 2

| | | | | | | | Average particle | | | | | |
|---|---|---|---|---|---|---|---|---|---|---|---|---|
| | | | | | | Polymer | diameter (Mv) | | | Mv/Mn | | |
| Example | Organic | Polymerization | Polymerizable | Polymerizable | | dispersing | Initial | 60° C. | 60° C. | Initial | 60° C. | 60° C. |
| No. | compound | initiator | compound | surfactant | Surfactant | agent | value | 100 hr | 240 hr | value | 100 hr | 240 hr |
| 10 | I-1 | K₂S₂O₈ | N-VP | KH10 | — | — | 28.0 | 28.2 | 28.2 | 1.46 | 1.47 | 1.48 |
| 11 | I-1 | K₂S₂O₈ | St | — | Sodium | — | 26.5 | 26.6 | 26.6 | 1.52 | 1.54 | 1.54 |
| | | | | | lauryl | | | | | | | |
| | | | | | sulfate | | | | | | | |
| 12 | I-1 | K₂S₂O₈ | 10% St | 90% KH10 | — | — | 25.9 | 25.9 | 26.0 | 1.41 | 1.42 | 1.42 |
| 13 | I-1 | K₂S₂O₈ | 10% | 90% KH10 | — | — | 24.4 | 24.6 | 24.8 | 1.47 | 1.47 | 1.48 |
| | | | Me-Acrylate | | | | | | | | | |
| 14 | I-1 | K₂S₂O₈ | 10% | 90% KH10 | — | — | 28.7 | 28.8 | 29.1 | 1.39 | 1.40 | 1.40 |
| | | | vinyl acetate | | | | | | | | | |
| 15 | I-1 | K₂S₂O₈ | 9% St, | 90% KH10 | — | — | 22.1 | 22.2 | 22.3 | 1.35 | 1.35 | 1.36 |
| | | | 1% DVB | | | | | | | | | |
| 16 | I-1 | K₂S₂O₈ | 5% St, | 90% KH10 | — | — | 23.7 | 23.8 | 23.9 | 1.40 | 1.41 | 1.44 |
| | | | 5% AA | | | | | | | | | |

As is apparent from these results, the organic fine particle dispersions prepared by the production method of the present invention are all superior in dispersion stability and storage stability.

### Example 17

In Example 10, the exemplary compound (I-1) was replaced with 1.0 g of (III-2); N-vinylpyrrolidone was replaced with styrene and divinylbenzene (ratio: 90:10, total amount: 0.5 g); and VPE0201 (trade name, manufactured by Wako Pure Chemical Industries, 0.5 g) and polyvinylpyrrolidone 1K30 (trade name, manufactured by Wako Pure Chemical Industries, 0.2 g) was dissolved in 50 mL, of tetrahydrofuran (THF) at room temperature (solution IB). Distilled water was used as solution IIB. These solutions were filtered through a 0.45-μm microfilter (manufactured by SARTORIUS K.K.) for removal of impurities such as foreign particles. An organic fine particle dispersion liquid was prepared in an apparatus by an operation similar to Example 1. The particle diameters determined before and after heat test and the results of monodispersibility measurement are summarized in the following Table 3.

### Example 18

An organic fine particle dispersion liquid was prepared in an apparatus and by an operation similar to Example 1, except that K₂S₂O₈ in Example 10 was replaced with 2,2′-azobis(2-amidinopropane) dihydrochloride (trade name: V-50, a product of Wako Pure Chemical Industries, Ltd.) in the same amount. The particle diameters determined before and after heat test and the results of monodispersibility measurement are summarized in the following Table 3.

### Examples 19 to 21

In Examples 10, 17 and 18, dispersion liquids were prepared in an apparatus by an operation similar to Example 1, except that the polymerizable compound was eliminated and the other conditions were changed to those shown in the following Table 3. The particle diameters determined before and after heat test and the results of monodispersibility measurement are summarized in the following Table 3.

TABLE 3

| | | | | | | | Average particle | | | | | |
|---|---|---|---|---|---|---|---|---|---|---|---|---|
| | | | | | | Polymer | diameter (Mv) | | | Mv/Mn | | |
| Example | Organic | Polymerization | Polymerizable | Polymerizable | | dispersing | Initial | 60° C. | 60° C. | Initial | 60° C. | 60° C. |
| No. | compound | initiator | compound | surfactant | Surfactant | agent | Value | 100 hr | 240 hr | value | 100 hr | 240 hr |
| 17 | III-2 | VPE0201 | St, DVB | — | — | PVP | 35.5 | 35.8 | 35.8 | 1.55 | 1.55 | 1.56 |
| 18 | I-1 | V-50 | N-VP | KH10 | — | — | 29.1 | 29.3 | 29.3 | 1.44 | 1.45 | 1.46 |
| 19 | I-1 | K₂S₂O₈ | — | KH10 | — | — | 32.2 | 32.3 | 32.6 | 1.49 | 1.52 | 1.53 |
| 20 | I-1 | VPE0201 | — | KH10 | — | — | 39.9 | 40.2 | 40.4 | 1.45 | 1.49 | 1.51 |
| 21 | I-1 | V-50 | — | KH10 | — | — | 34.4 | 34.5 | 34.9 | 1.44 | 1.47 | 1.48 |

As is apparent from these results, the organic fine particle dispersions prepared by the production method of the present invention are all superior both in dispersion stability and storage stability.

### Example 22

In Example 10, five reactors are placed in parallel, and the solutions were supplied through two manifolds connected to two syringes, dividing the solutions respective into five streams. A dispersion I-1 was collected, as the flow rate of one reactor was kept constant, and the volume-average particle diameter Mv of the particles therein was 28.2 nm, and the ratio of volume-average particle diameter Mv/number-average particle diameter Mn thereof, which is an indicator of monodispersibility, was 1.47. As described above, it was found that there was almost no fluctuation in the properties of fine particles by numbering-up and the yield could be raised five times, while favorable fine particle properties were preserved.

Having described our invention as related to the present embodiments, it is our intention that the invention not be limited by any of the details of the description, unless otherwise specified, but rather be construed broadly within its spirit and scope as set out in the accompanying claims.

What we claim is:

1. A method of producing a polymer-processed organic fine particle dispersion, comprising a step of: feeding an organic fine particle dispersion containing a polymerizable compound in a channel and polymerizing the polymerizable compound during the flow of the dispersion in the channel.

2. The method of producing a polymer-processed organic pigment fine particle dispersion according to claim 1, wherein the volume average particle diameter (Mv) of organic fine particles is from 10 nm to 50 nm.

3. The method of producing a polymer-processed organic pigment fine particle dispersion according to claim 1, wherein the polymerizable compound is polymerized in a radical polymerization reaction.

4. The method of producing a polymer-processed organic fine particle dispersion according to claimi 1, wherein the polymerizable compound is polymerized in a radical polymerization reaction by using a water-soluble polymerization initiator.

5. The method of producing a polymer-processed organic fine particle dispersion according to claim 1, wherein the polymerizable compound includes N-vinylpyrrolidone.

6. The method of producing a polymer-processed organic fine particle dispersion according to claim 1, wherein the polymerizable compound includes one or more polymerizable surfactant.

7. The method of producing a polymer-processed organic fine particle dispersion according to claim 1, wherein the equivalent diameter of the channel used in the polymerization step is 0.1 mm or more and 16 mm or less.

8. The method of producing a polymer-processed organic fine particle dispersion according to claim 1, wherein the polymerization step is carried out at a temperature of 50° C. to 100° C.

9. The method of producing a polymer-processed organic fine particle dispersion according to claim 1, wherein the organic fine particles to be polymer-processed are organic fine particles prepared by a build-up method.

10. The method of producing a polymer-processed organic fine particle dispersion according to claim 1, wherein after preparation of the organic fine particle dispersion in the step of mixing a solution containing a dissolved organic compound with a precipitation medium and bringing them into contact with each other during flow in a microreactor apparatus, the organic pigment fine particle dispersion obtained is added with a polymerizable compound and subjected to polymerization processing.

11. The method of producing a polymer-processed organic fine particle dispersion according to claim 1, wherein the precipitation medium precipitating the organic compound is an aqueous medium.

12. The method of producing a polymer-processed organic fine particle dispersion according to claim 1, wherein the solution containing a dissolved organic compound is a solution obtained by dissolving the organic compound with an acid or alkali.

13. The method of producing a polymer-processed organic fine particle dispersion according to claim 9, wherein the organic fine particle dispersion containing a polymerizable compound is a dispersion obtained by adding a polymerizable compound to the solution containing a dissolved organic compound and adding a water-soluble radical polymerization initiator to the precipitation medium.

14. The method of producing a polymer-processed organic fine particle dispersion according to claim 1, wherein, when the liquid stream of the solution containing a dissolved organic compound and the liquid stream of the precipitation medium are mixed as they are joined, at least one liquid stream is divided into multiple substreams, the center axis of at least one substream of the divided multiple substreams and the center axis of the other liquid stream are mixed as they are joined crosswise at a point in the junction region.

15. The method of producing a polymer-processed organic fine particle dispersion according to claim 14, wherein the multiple substreams are supplied through channels extending radially from the central junction region into the central junction region and are mixed as they are joined there.

16. The method of producing a polymer-processed organic fine particle dispersion according to claim 10, wherein the step of precipitating the fine particles and the subsequent heating treatment step during the flow of the dispersion in the channel are performed under a series of liquid feedings by use of the microreactor apparatus.

17. The method of producing a polymer-processed organic fine particle dispersion according to claim 1, wherein the organic fine particles are organic pigment fine particles.

18. An ink-jet recording ink, comprising a polymer-processed organic pigment fine particle dispersion which is an aqueous dispersion produced by the method of producing according to claim 1.

19. A paint, comprising a polymer-processed organic pigment fine particle dispersion which is an aqueous dispersion produced by the method of producing according to claim 1.
